(19) United States
(12) Patent Application Publication
(10) Pub. No.: US 2025/0240814 A1
(43) Pub. Date: Jul. 24, 2025

(54) SIDELINK CHANNEL OCCUPANCY TIME SHARING RESOURCE AWARENESS

(71) Applicant: QUALCOMM INCORPORATED, San Diego, CA (US)

(72) Inventors: Siyi Chen, Beijing (CN); Jing Sun, San Diego, CA (US); Xiaoxia Zhang, San Diego, CA (US); Changlong Xu, Beijing (CN); Shaozhen Guo, Beijing (CN); Luanxia Yang, Beijing (CN); Hao Xu, Beijing (CN)

(21) Appl. No.: 18/700,672

(22) PCT Filed: Dec. 17, 2021
(86) PCT No.: PCT/CN2021/139151

§ 371 Date: Apr. 11, 2024

(51) Int. Cl. H04W 74/04; H04W 16/14; H04W 92/18

(52) U.S. Cl. CPC H04W 74/04; H04W 16/14; H04W 92/18

(57) ABSTRACT

Methods, systems, and devices for wireless communications are described. A user equipment (UE) may operate in an unlicensed spectrum, and may operate in a frame based equipment (FBE) mode or a load based equipment (LBE) mode. The UE may communicate with other UEs using sidelink communication links (e.g., without base station control) during a channel occupancy time (COT) and according to a fixed frame period (FFP) configuration or structure. To avoid transmission conflicts during COTs, a UE may obtain (e.g., receive) other UE FFP configurations from the other UEs, from a base station, or both. Additionally or alternatively, the UE may indicate a set of resources to other UEs that may be shared for a sidelink transmission. For example, each UE may be able to transmit sidelink communications during different portions of the set of resources so that conflicts may be avoided.

### CROSS REFERENCE

The present application is a 371 national stage filing of International PCT Application No. PCT/CN2021/139151 by CHEN et al. entitled “SIDELINK CHANNEL OCCUPANCY TIME SHARING RESOURCE AWARENESS,” filed Dec. 17, 2021, which is assigned to the assignee hereof, and which is expressly incorporated by reference in its entirety herein.

### FIELD OF TECHNOLOGY

The following relates to wireless communications, including sidelink channel occupancy time (COT) sharing resource awareness.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In unlicensed spectrums, a UE may share a channel occupancy time (COT) with a base station for downlink-to-uplink COT sharing. In such cases, the base station may control communications between the UE and the base station to mitigate collisions. However, the UE may communicate using sidelink communication links with one or more other UEs, and thus collisions may occur during a COT as a UE may not be capable of controlling other UE communications in such scenarios.

### SUMMARY

The described techniques relate to improved techniques, devices, and apparatuses that support sidelink channel occupancy time (COT) sharing resource awareness. The described techniques provide a solution where a user equipment (UE) may operate in an unlicensed spectrum, and may operate in a frame based equipment (FBE) mode or a load based equipment (LBE) mode. The UE may communicate with other UEs using sidelink communication links (e.g., without base station control) during a COT and according to a fixed frame period (FFP) configuration or structure. To avoid transmission conflicts during COTs, a UE may obtain (e.g., receive) other UE FFP configurations from the other UEs, from a base station, or both. Additionally or alternatively, the UE may indicate a set of resources to other UEs that may be shared for a sidelink transmission. For example, each UE may be able to transmit sidelink communications during different portions of the set of resources so that conflicts may be avoided. By receiving other UE FFP configurations from the other UEs or a base station, indicating shared resources to other UEs, or both, UEs in unlicensed spectrums communicating using sidelink communication links may reduce transmission conflicts with other transmissions from other UEs.

A method for wireless communication at a first user equipment (UE) is described. The method may include identifying that the first UE is operating in an unlicensed spectrum and in an FBE mode or an LBE mode for sidelink communications, receiving, from a second UE, a message indicating one or more shared resources during a COT, where the one or more shared resources are available for the first UE to use for sidelink transmissions, and transmitting, to a third UE, a sidelink transmission using the one or more shared resources.

An apparatus for wireless communication at a first UE is described. The apparatus may include a processor, memory coupled with the processor, and instructions stored in the memory. The instructions may be executable by the processor to cause the apparatus to identify that the first UE is operating in an unlicensed spectrum and in a FBE mode or a LBE mode for sidelink communications, receive, from a second UE, a message indicating one or more shared resources during a COT, where the one or more shared resources are available for the first UE to use for sidelink transmissions, and transmit, to a third UE, a sidelink transmission using the one or more shared resources.

Another apparatus for wireless communication at a first UE is described. The apparatus may include means for identifying that the first UE is operating in an unlicensed spectrum and in a FBE mode or a LBE mode for sidelink communications, means for receiving, from a second UE, a message indicating one or more shared resources during a COT, where the one or more shared resources are available for the first UE to use for sidelink transmissions, and means for transmitting, to a third UE, a sidelink transmission using the one or more shared resources.

A non-transitory computer-readable medium storing code for wireless communication at a first UE is described. The code may include instructions executable by a processor to identify that the first UE is operating in an unlicensed spectrum and in a FBE mode or a LBE mode for sidelink communications, receive, from a second UE, a message indicating one or more shared resources during a COT, where the one or more shared resources are available for the first UE to use for sidelink transmissions, and transmit, to a third UE, a sidelink transmission using the one or more shared resources.

In some examples of the method, apparatuses, and non-transitory computer-readable medium described herein, receiving the message may include operations, features, means, or instructions for receiving, via the message, a single bit that indicates whether the first UE may be allowed to transmit the sidelink transmission using the one or more shared resources during a duration between when the first UE receives the message and an end of the COT.

In some examples of the method, apparatuses, and non-transitory computer-readable medium described herein, receiving the message may include operations, features, means, or instructions for receiving the message via unicast.

In some examples of the method, apparatuses, and non-transitory computer-readable medium described herein, the one or more shared resources may be based on a transmission time of the message indicating the one or more shared resources.

In some examples of the method, apparatuses, and non-transitory computer-readable medium described herein, receiving the message may include operations, features, means, or instructions for receiving, via the message, a bitmap that indicates the one or more shared resources, where at least one bit of the bitmap indicates a shared resource of the one or more shared resources that may be in relation to the transmission time of the message indicating the one or more shared resources.

In some examples of the method, apparatuses, and non-transitory computer-readable medium described herein, receiving the message may include operations, features, means, or instructions for receiving, via the message, one or more start and length indicator values (SLIVs) for the one or more shared resources.

In some examples of the method, apparatuses, and non-transitory computer-readable medium described herein, the one or more shared resources may be based on an offset and a duration related to a FFP structure of the second UE.

Some examples of the method, apparatuses, and non-transitory computer-readable medium described herein may further include operations, features, means, or instructions for receiving, from a base station, a table indicating the one or more shared resources.

In some examples of the method, apparatuses, and non-transitory computer-readable medium described herein, receiving the message may include operations, features, means, or instructions for receiving, from the second UE, a shared resource index and determining the one or more shared resources during the COT based on accessing the table using the shared resource index.

In some examples of the method, apparatuses, and non-transitory computer-readable medium described herein, receiving the message may include operations, features, means, or instructions for receiving, from the second UE, a single bit resource sharing indication that indicates that a first symbol of the COT may be a shared resource.

In some examples of the method, apparatuses, and non-transitory computer-readable medium described herein, the first symbol of the single bit resource sharing indication represents a first value plus a second value and the first value may be an end of a slot with which the first UE receives the single bit resource sharing indication and the second value may be a quantity of symbols from the end of the slot with which the first UE receives the single bit resource sharing indication.

In some examples of the method, apparatuses, and non-transitory computer-readable medium described herein, receiving the message may include operations, features, means, or instructions for receiving the message via groupcast.

A method for wireless communication at a first UE is described. The method may include identifying that the first UE and a second UE are operating in an unlicensed spectrum and in a FBE mode or a LBE mode for sidelink communications and transmitting, to the second UE, a first message indicating a first portion of one or more shared resources during a COT, where the first portion of the one or more shared resources are available for the second UE to use for first sidelink transmissions.

An apparatus for wireless communication at a first UE is described. The apparatus may include a processor, memory coupled with the processor, and instructions stored in the memory. The instructions may be executable by the processor to cause the apparatus to identify that the first UE and a second UE are operating in an unlicensed spectrum and in a FBE mode or a LBE mode for sidelink communications and transmit, to the second UE, a first message indicating a first portion of one or more shared resources during a COT, where the first portion of the one or more shared resources are available for the second UE to use for first sidelink transmissions.

Another apparatus for wireless communication at a first UE is described. The apparatus may include means for identifying that the first UE and a second UE are operating in an unlicensed spectrum and in a FBE mode or a LBE mode for sidelink communications and means for transmitting, to the second UE, a first message indicating a first portion of one or more shared resources during a COT, where the first portion of the one or more shared resources are available for the second UE to use for first sidelink transmissions.

A non-transitory computer-readable medium storing code for wireless communication at a first UE is described. The code may include instructions executable by a processor to identify that the first UE and a second UE are operating in an unlicensed spectrum and in a FBE mode or a LBE mode for sidelink communications and transmit, to the second UE, a first message indicating a first portion of one or more shared resources during a COT, where the first portion of the one or more shared resources are available for the second UE to use for first sidelink transmissions.

In some examples of the method, apparatuses, and non-transitory computer-readable medium described herein, transmitting the first message may include operations, features, means, or instructions for transmitting, to a third UE, a second message indicating a second portion of the one or more shared resources during the COT, where the second portion of the one or more shared resources may be available for the third UE to use for second sidelink transmissions.

In some examples of the method, apparatuses, and non-transitory computer-readable medium described herein, transmitting the first message may include operations, features, means, or instructions for transmitting, via the first message, a single bit that indicates whether the second UE may be allowed to transmit the first sidelink transmissions using the first portion of the one or more shared resources during a duration between when the second UE receives the first message and an end of the COT.

In some examples of the method, apparatuses, and non-transitory computer-readable medium described herein, transmitting the first message may include operations, features, means, or instructions for transmitting the first message to the second UE via unicast.

In some examples of the method, apparatuses, and non-transitory computer-readable medium described herein, the one or more shared resources may be based on a transmission time of the first message indicating the one or more shared resources.

In some examples of the method, apparatuses, and non-transitory computer-readable medium described herein, transmitting the first message may include operations, features, means, or instructions for transmitting, via the first message, a bitmap that indicates the one or more shared resources, where at least one bit of the bitmap indicates a shared resource of the one or more shared resources that may be in relation to the transmission time of the first message indicating the one or more shared resources.

In some examples of the method, apparatuses, and non-transitory computer-readable medium described herein, transmitting the first message may include operations, features, means, or instructions for transmitting, via the first message, one or more SLIVs for the one or more shared resources.

In some examples of the method, apparatuses, and non-transitory computer-readable medium described herein, the one or more shared resources may be based on an offset and a duration related to a FFP structure of the first UE.

A method for wireless communication at a first UE is described. The method may include identifying that the first UE is operating in an unlicensed spectrum and in a FBE mode for sidelink communications, receiving, from a first wireless device, a FFP configuration for a second wireless device, the FFP configuration indicating a period and a time offset for the second wireless device, determining a transmission duration for sidelink communications with a second UE based on the FFP configuration for the second wireless device, and transmitting, to the second UE, a sidelink message during the transmission duration.

An apparatus for wireless communication at a first UE is described. The apparatus may include a processor, memory coupled with the processor, and instructions stored in the memory. The instructions may be executable by the processor to cause the apparatus to identify that the first UE is operating in an unlicensed spectrum and in a FBE mode for sidelink communications, receive, from a first wireless device, a FFP configuration for a second wireless device, the FFP configuration indicating a period and a time offset for the second wireless device, determine a transmission duration for sidelink communications with a second UE based on the FFP configuration for the second wireless device, and transmit, to the second UE, a sidelink message during the transmission duration.

Another apparatus for wireless communication at a first UE is described. The apparatus may include means for identifying that the first UE is operating in an unlicensed spectrum and in a FBE mode for sidelink communications, means for receiving, from a first wireless device, a FFP configuration for a second wireless device, the FFP configuration indicating a period and a time offset for the second wireless device, means for determining a transmission duration for sidelink communications with a second UE based on the FFP configuration for the second wireless device, and means for transmitting, to the second UE, a sidelink message during the transmission duration.

A non-transitory computer-readable medium storing code for wireless communication at a first UE is described. The code may include instructions executable by a processor to identify that the first UE is operating in an unlicensed spectrum and in a FBE mode for sidelink communications, receive, from a first wireless device, a FFP configuration for a second wireless device, the FFP configuration indicating a period and a time offset for the second wireless device, determine a transmission duration for sidelink communications with a second UE based on the FFP configuration for the second wireless device, and transmit, to the second UE, a sidelink message during the transmission duration.

In some examples of the method, apparatuses, and non-transitory computer-readable medium described herein, receiving the FFP configuration may include operations, features, means, or instructions for receiving the FFP configuration for the second wireless device from a base station.

In some examples of the method, apparatuses, and non-transitory computer-readable medium described herein, receiving the FFP configuration may include operations, features, means, or instructions for receiving a table from the base station, where the table includes the FFP configuration and an identifier of the second wireless device.

In some examples of the method, apparatuses, and non-transitory computer-readable medium described herein, receiving the FFP configuration may include operations, features, means, or instructions for receiving the FFP configuration from the second UE, where the FFP configuration may be for the second UE.

In some examples of the method, apparatuses, and non-transitory computer-readable medium described herein, receiving the FFP configuration may include operations, features, means, or instructions for receiving a table from a base station, where the table includes a set of multiple FFP configurations corresponding to a set of multiple UEs.

In some examples of the method, apparatuses, and non-transitory computer-readable medium described herein, receiving the FFP configuration may include operations, features, means, or instructions for receiving, from the second UE, a table index indicating one FFP configuration of the set of multiple FFP configurations of the table based on receiving the table from the base station.

In some examples of the method, apparatuses, and non-transitory computer-readable medium described herein, receiving the FFP configuration may include operations, features, means, or instructions for receiving, from the second UE, sidelink control information (SCI), the SCI indicating the FFP configuration for the second UE.

A method for wireless communication at a base station is described. The method may include identifying that a first UE is operating in an unlicensed spectrum and in a FBE mode for sidelink communications, determining a FFP configuration for a first wireless device, the FFP configuration indicating a period and a time offset for the first wireless device, and transmitting, to the first UE, the FFP configuration for the first wireless device.

An apparatus for wireless communication at a base station is described. The apparatus may include a processor, memory coupled with the processor, and instructions stored in the memory. The instructions may be executable by the processor to cause the apparatus to identify that a first UE is operating in an unlicensed spectrum and in a FBE mode for sidelink communications, determine a FFP configuration for a first wireless device, the FFP configuration indicating a period and a time offset for the first wireless device, and transmit, to the first UE, the FFP configuration for the first wireless device.

Another apparatus for wireless communication at a base station is described. The apparatus may include means for identifying that a first UE is operating in an unlicensed spectrum and in a FBE mode for sidelink communications, means for determining a FFP configuration for a first wireless device, the FFP configuration indicating a period and a time offset for the first wireless device, and means for transmitting, to the first UE, the FFP configuration for the first wireless device.

A non-transitory computer-readable medium storing code for wireless communication at a base station is described. The code may include instructions executable by a processor to identify that a first UE is operating in an unlicensed spectrum and in a FBE mode for sidelink communications, determine a FFP configuration for a first wireless device, the FFP configuration indicating a period and a time offset for the first wireless device, and transmit, to the first UE, the FFP configuration for the first wireless device.

In some examples of the method, apparatuses, and non-transitory computer-readable medium described herein, transmitting the FFP configuration may include operations, features, means, or instructions for transmitting a table to the first UE, where the table includes the FFP configuration for the first wireless device and an identifier of the first wireless device.

In some examples of the method, apparatuses, and non-transitory computer-readable medium described herein, transmitting the FFP configuration may include operations, features, means, or instructions for transmitting a table to the first UE, where the table includes a set of multiple FFP configurations corresponding to a set of multiple UEs.

### BRIEF DESCRIPTION OF THE DRAWINGS

FIG. 1 illustrates an example of a wireless communications system that supports sidelink channel occupancy time (COT) sharing resource awareness in accordance with aspects of the present disclosure.

FIG. 2 illustrates an example of a wireless communications system that supports sidelink COT sharing resource awareness in accordance with aspects of the present disclosure.

FIG. 3A illustrates an example of a timeline that supports sidelink COT sharing resource awareness in accordance with aspects of the present disclosure.

FIG. 3B illustrates an example of a timeline that supports sidelink COT sharing resource awareness in accordance with aspects of the present disclosure.

FIG. 4A illustrates an example of a timeline that supports sidelink COT sharing resource awareness in accordance with aspects of the present disclosure.

FIG. 4B illustrates an example of a timeline that supports sidelink COT sharing resource awareness in accordance with aspects of the present disclosure.

FIG. 5A illustrates an example of a timeline that supports sidelink COT sharing resource awareness in accordance with aspects of the present disclosure.

FIG. 5B illustrates an example of a timeline that supports sidelink COT sharing resource awareness in accordance with aspects of the present disclosure.

FIG. 5C illustrates an example of a timeline that supports sidelink COT sharing resource awareness in accordance with aspects of the present disclosure.

FIG. 6 illustrates an example of a process flow that supports sidelink COT sharing resource awareness in accordance with aspects of the present disclosure.

FIG. 7 illustrates an example of a process flow that supports sidelink COT sharing resource awareness in accordance with aspects of the present disclosure.

FIGS. 8 and 9 show block diagrams of devices that support sidelink COT sharing resource awareness in accordance with aspects of the present disclosure.

FIG. 10 shows a block diagram of a communications manager that supports sidelink COT sharing resource awareness in accordance with aspects of the present disclosure.

FIG. 11 shows a diagram of a system including a device that supports sidelink COT sharing resource awareness in accordance with aspects of the present disclosure.

FIGS. 12 and 13 show block diagrams of devices that support sidelink COT sharing resource awareness in accordance with aspects of the present disclosure.

FIG. 14 shows a block diagram of a communications manager that supports sidelink COT sharing resource awareness in accordance with aspects of the present disclosure.

FIG. 15 shows a diagram of a system including a device that supports sidelink COT sharing resource awareness in accordance with aspects of the present disclosure.

FIGS. 16 through 19 show flowcharts illustrating methods that support sidelink COT sharing resource awareness in accordance with aspects of the present disclosure.

### DETAILED DESCRIPTION

In some wireless communications systems, a user equipment (UE) may operate in an unlicensed spectrum, and may operate in a frame based equipment (FBE) mode or a load based equipment (LBE) mode. The UE may communicate with a base station using uplink and downlink communication links, and may share a channel occupancy time (COT) with the base station for such communications. In some examples, the UE may receive a fixed frame period (FFP) configuration from the base station, and may be able to communicate based on the FFP configuration. In some other examples, the base station may be able to transmit a downlink transmission after receiving an uplink transmission during a COT since the base station may be able to control the scheduling and avoid transmission conflicts. However, for sidelink communications between UEs (e.g., without base station scheduling), a UE may not be able to determine a FFP configuration or structure for another UE, and transmission conflicts may occur if both UEs use a common FFP configuration. Further, as the base station may not be able to provide centralized scheduling for some sidelink communications, UEs may independently transmit sidelink transmissions from an end of a sidelink transmission (e.g., without performing a listen before talk (LBT) procedure), and may result in collisions between transmissions from various UEs.

To avoid transmission conflicts and collisions, a UE may obtain (e.g., receive) other UE FFP configurations from the other UEs, from a base station, or both. For example, the UE may receive an FFP configuration for another UE from the base station. In some other examples, the UE may receive a table from the base station indicating FFP configurations and corresponding UEs (e.g., UE IDs). In some other examples, the UE may receive a broadcasted message (e.g., control signaling (e.g., radio resource control (RRC) signaling), sidelink control information (SCI), or the like) indicating a UE FFP configuration. In some other examples, the UE may receive a table index from another UE, and the UE may access a table using the table index to determine an FFP configuration. Additionally or alternatively, the UE may indicate a set of resources to other UEs that may be shared for a sidelink transmission. For example, each UE may be able to transmit sidelink communications during different portions of the set of resources so that conflicts may be avoided. In some examples, the shared resources may be based on the indication transmission time, an FFP structure of the UE indicating the set of resources (e.g., the initiating UE), or both. In some examples, the UE may indicate the set of resources via a preconfigured table. By receiving other UE FFP configurations from the other UEs or a base station, indicating shared resources to other UEs, or both, UEs in unlicensed spectrums communicating using sidelink communication links may reduce transmission conflicts with other transmissions from other UEs.

Aspects of the disclosure are initially described in the context of wireless communications systems. Aspects of the disclosure are further illustrated by and described with reference to timelines, process flows, apparatus diagrams, system diagrams, and flowcharts that relate to sidelink COT sharing resource awareness.

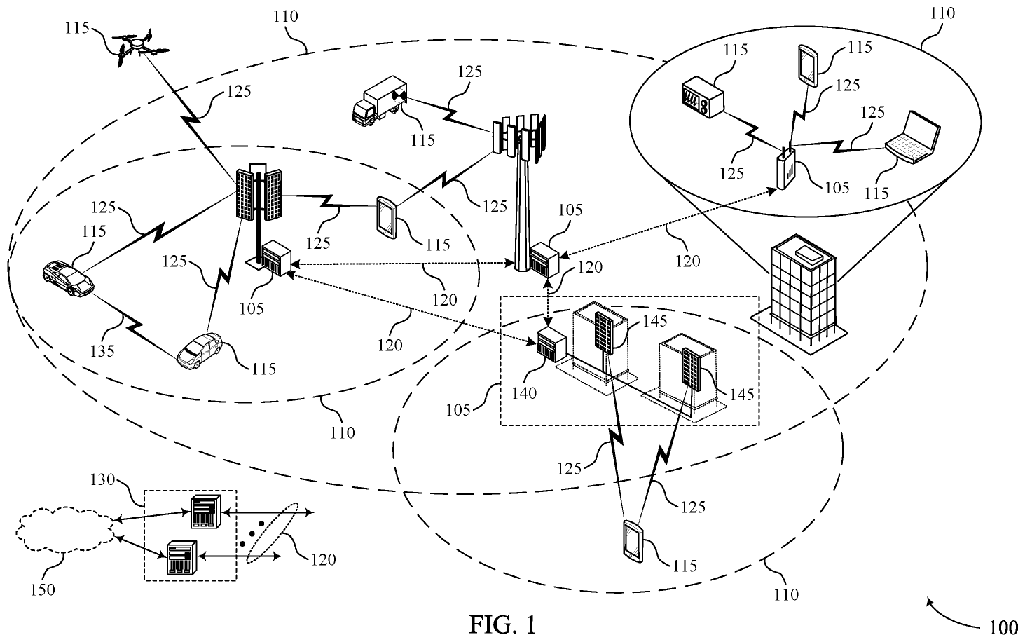

FIG. 1 illustrates an example of a wireless communications system 100 that supports sidelink COT sharing resource awareness in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

In some wireless communications systems, a UE 115 may operate in an unlicensed spectrum, and may operate in an FBE mode or an LBE mode. The UE 115 may communicate with other UEs 115 using sidelink communication links (e.g., communication links 125, D2D communication links 135, or the like) (e.g., without base station 105 control) during a COT and according to an FFP configuration or structure. To avoid transmission conflicts during COTs, a UE may obtain (e.g., receive) other UE FFP configurations from the other UEs 115, from a base station 105, or both. Additionally or alternatively, the UE 115 may indicate a set of resources to other UEs 115 that may be shared for a sidelink transmission. For example, each UE 115 may be able to transmit sidelink communications during different portions of the set of resources so that conflicts may be avoided. By receiving other UE FFP configurations from the other UEs 115 or a base station 105, indicating shared resources to other UEs 115, or both, UEs 115 in unlicensed spectrums communicating using sidelink communication links may reduce transmission conflicts with other transmissions from other UEs 115.

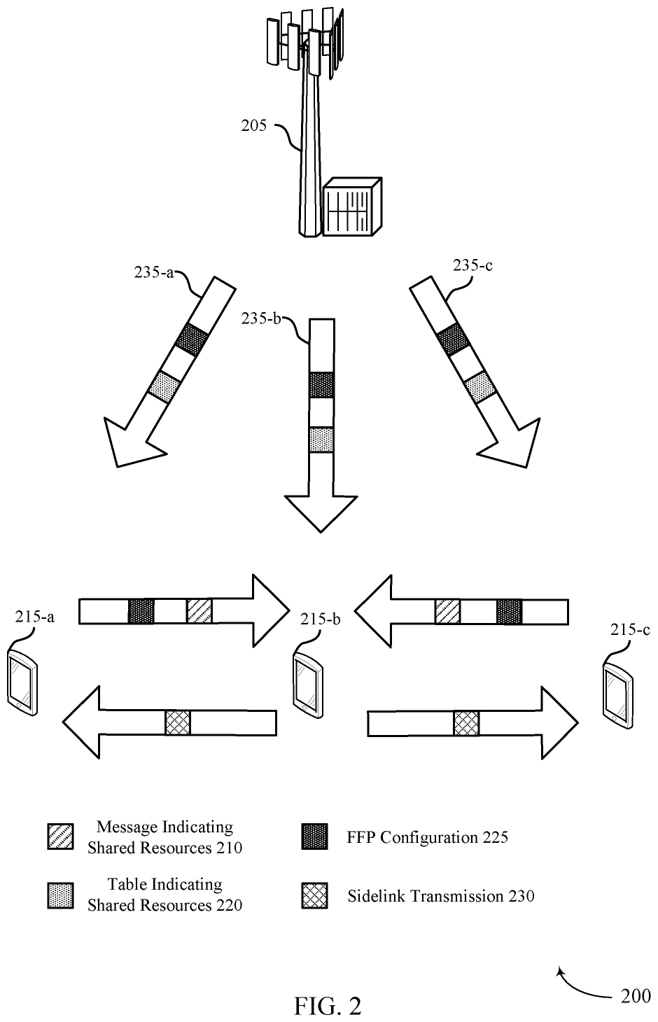

FIG. 2 illustrates an example of a wireless communications system 200 that supports sidelink COT sharing resource awareness in accordance with aspects of the present disclosure. The wireless communications system 200 may implement or be implemented by aspects of the wireless communications system 100 as described with reference to FIG. 1. For example, the wireless communications system 200 may include base station 205 and UEs 215, which may be examples of a base station 205 and UEs 215, or any other devices, as described herein. The wireless communications system 200 may support improvements to interference, processing, power consumption, and more efficient utilization of communication resources, among other benefits.

The wireless communications system 200 may support communications over unlicensed radio frequency spectrum. Using unlicensed radio frequency spectrum bands may enable sidelink communications between two devices without incurring the usage of licensed spectrum. In some implementations, the wireless communications system 200 may support COT sharing, such as uplink-to-downlink or downlink-to-uplink COT sharing and group common uplink-to-downlink COT sharing. UEs 215 may also communicate on one or more sidelink communication links. Some wireless communications systems may use a sidelink communication link for D2D communications, UE to UE communications, V2X communications, or the like.

In wireless communications system 200, a UE 215 may operate in an unlicensed spectrum, and may operate in an FBE mode or an LBE mode. The FBE mode may be referred to as semi-static channel access procedures, and UEs 215 may be configured to use semi-static channel access procedures to obtain COT, such as by performing LBT procedures in accordance with an FFP configuration.

In some implementations, the wireless communications system 200 may support UE-to-UE COT sharing, which may provide enhanced medium access for sidelink communications. For example, for LBE, COT sharing may enable one node to share a COT with other nodes so the other nodes do not perform a category (Cat) 4 LBT. This can improve the chances of transmitting for the other nodes. For FBE, a second node may join a COT acquired by a first node without accessing the medium in the beginning of each FFP, which may provide the second node additional transmission opportunities.

A UE 215 may communicate with a base station 205 using uplink and downlink communication links, and may share a COT with the base station for such communications. In some examples, the UE 215 may receive a FFP configuration from the base station 205, and may be able to communicate based on the FFP configuration. In some other examples, the base station 205 may be able to transmit a downlink transmission after receiving an uplink transmission during a COT since the base station 205 may be able to control the scheduling and avoid transmission conflicts. However, for sidelink communications between UEs 215 (e.g., without base station scheduling), a UE 215 may not be able to determine a FFP configuration or structure for another UE 215, and transmission conflicts may occur if both UEs 215 use a common FFP configuration. Further, as the base station 205 may not be able to provide centralized scheduling for some sidelink communications, UEs 215 may independently transmit sidelink transmissions from an end of a sidelink transmission (e.g., without performing an LBT procedure in cases where a UE 215 may share a sidelink COT with another UE 215 and where a gap between sidelink transmissions of UEs 215 is less than 16 microseconds), and may result in collisions between transmissions from various UEs 215.

To avoid transmission conflicts and collisions, UE 215-b may obtain (e.g., receive) other UE FFP configurations 225 (e.g., which may include an indication of a starting time, a period, a time offset, or any combination of these) from the other UEs 215, from a base station, or both. For example, UE 215-b may receive an FFP configuration 225 for another UE 215 from the base station 205 via a downlink communication link 235. In some other examples, UE 215-b may receive a table 220 from base station 205 via a downlink communication link 235 indicating FFP configurations and corresponding UEs 215 (e.g., UE IDs). In some other examples, UE 215-b may receive a broadcasted message 210 (e.g., control signaling (e.g., RRC signaling), SCI, or the like) indicating a UE FFP configuration. In some other examples, the UE may receive a table index from another UE 215 (e.g., via a message 210), and the UE 215 may access a table using the table index to determine an FFP configuration. Additionally or alternatively, UEs 215 may indicate a set of resources to other UEs 215 (e.g., via message 210) that may be shared for a sidelink transmission 230. For example, each UE 215 may be able to transmit sidelink transmissions 230 during different portions of the set of resources so that conflicts may be avoided. In some examples, the shared resources may be based on the indication transmission time, an FFP structure of UE 215 indicating the set of resources (e.g., the initiating UE 215), or both. In some examples, the UE 215 may indicate the set of resources via a preconfigured table. By receiving other UE FFP configurations from the other UEs 215 or base station 205, indicating shared resources to other UEs 215, or both, UEs 215 in unlicensed spectrums communicating using sidelink communication links may reduce transmission conflicts with other transmissions from other UEs 215.

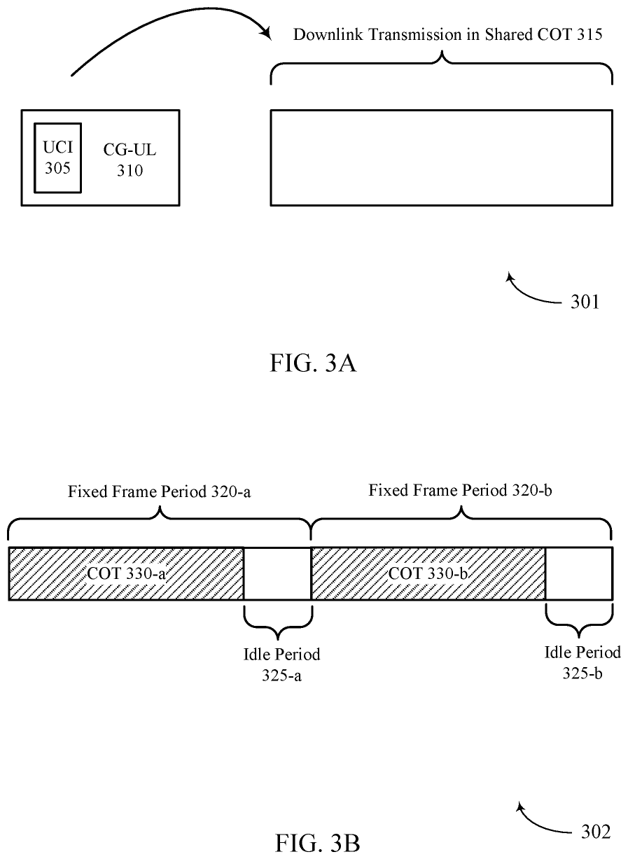

FIG. 3A illustrates an example of a timeline 301 that supports sidelink COT sharing resource awareness in accordance with aspects of the present disclosure. The timeline 301 may implement or be implemented by aspects of the wireless communications system 100, wireless communications system 200, or both, as described with reference to FIG. 1 and FIG. 2.

In some implementations, a wireless communications system using unlicensed radio frequency spectrum bands may support devices to share a COT. When a wireless device (such as a UE 215) successfully performs a clear channel assessment (CCA), such as an LBT, the wireless device is given a COT to perform wireless communications. The wireless device may share the COT with another wireless device, which may improve medium access within the COT from one node to another node.

For example, the wireless communications system 100 may support uplink and downlink COT sharing. A base station may acquire a COT with an extended CCA and share the COT with multiple UEs for the UEs to transmit uplink signals. Within the COT acquired by the base station 205, a UE may use a single shot CCA for the uplink transmission. In some implementations, a UE may not perform an LBT to begin an uplink transmission in the shared COT. In some implementations, the type of LBT performed by the UE may be based on certain conditions. For example, a Category 2 LBT may be used for a certain durations of downlink-to-uplink gaps (such as between gaps of approximately 16 microseconds and 25 microseconds or gaps beyond 25 us within a gNB or base station acquired COT), and a Category 1 LBT may be used for smaller downlink-to-uplink gaps (such as gaps shorter than approximately 16 microseconds).

In some implementations, the wireless communications system 200 may support uplink-to-downlink COT sharing. For example, a UE may acquire the COT and share the COT with a base station 205. For example, a UE may transmit uplink control information (UCI) 305 in a configured grant for uplink (CG-UL) 310. The base station may then transmit a downlink transmission in shared COT 315. In some implementations, the channel occupancy acquired by the UE may be for a group common uplink shared channel or a scheduled uplink transmission. The base station may transmit control signaling, broadcast signals, or various channels for multiple UEs 215, including at least the UE that initiated the channel occupancy. The UE may apply an energy density (ED) threshold configured by the base station when initiating a channel occupancy that is to be shared with the base station 205. In some implementations, the ED threshold may be configured via RRC signaling. If the ED threshold is not configured, the transmission of a base station in a UE-initiated COT may include a limited number of OFDM symbols. For example, the base station may send up to 2, 4, or 8 OFDM symbols for, respectively, 15 kHz, 30 kHz, and 60 kHz subcarrier spacing for control signaling, broadcast signaling, or data or control channels. If the base station cannot determine the presence, or lack there-of, of Wi-Fi, the ED threshold configured by the base station may be determined based on the maximum transmit power of the base station 205. In some implementations, similar to downlink-to-uplink COT sharing, a Category 2 LBT may be used by a base station 205, for uplink-to-downlink gap durations between approximately 16 microseconds and 25 microseconds or gaps beyond 25 us within UE acquired COT, and a Category 1 LBT may be used for uplink-to-downlink gap durations less than or equal to approximately 16 microseconds.

An LBT procedure may include different Categories for attempting to access an unlicensed frequency band. For example, a Category 1 LBT may enable a UE (or a different device) to transmit a message on the unlicensed frequency band after a switching gap of approximately 16 microseconds. A Category 2 LBT may include an LBT without a random back-off, in which a CCA period (that is, a time duration where a device listens to the unlicensed frequency band to determine if signaling is present or not) is deterministic (for example, a duration of time that the channel is sensed to be idle or not before a transmitting entity transmits may be deterministic, such as fixed to 25 microseconds). A Category 3 LBT may include an LBT with a random back-off with a contention window of a fixed size, in which an extended CCA period is drawn by a random number within a fixed contention window (that is, a random number is used in the LBT procedure to determine the duration of time that the channel is sensed to be idle or not before the transmitting entity transmits on the channel). A Category 4 LBT may include an LBT with a random back-off with a contention window of a variable size, in which an extended CCA period is drawn by a random number within a contention window, whose size can vary based on channel dynamics (that is, the transmitting entity can vary the size of the contention window when drawing a random number, and the random number is used in the LBT procedure to determine the duration of time that the channel is sensed to be idle before the transmitting entity transmits on the channel). The different Categories may be used for different scenarios. For example, the Category 4 LBT may be used by a base station or a UE to initiate a COT for data transmissions, while a base station may use the Category 2 LBT for signaling such as discovery reference signals.

In some implementations, the wireless communications system 100 may support group common uplink-to-downlink COT sharing. When an uplink-to-downlink sharing ED threshold is configured, the base station also may configure a table for sharing parameters. Each row of the table may include a number of slots where downlink transmissions can be assumed within the UE-initiated COT, a downlink offset (such as in a number of slots) from the end of the slot indicating a starting slot of the downlink transmission, and a channel access priority class of the traffic. In some implementations, one row of the table may indicate no COT sharing information. In some implementations, the UE may include an indication in UCI for the COT sharing. If the uplink-to-downlink COT sharing ED threshold is not configured, group common uplink control information may include a one-bit COT sharing indication. The one-bit COT sharing indication may indicate if TTI (such as a slot or symbol) n+X is an applicable slot for uplink-to-downlink sharing. In some implementations, the value for X may be configured by the base station as part of RRC configuration. X may be a number of symbols from the end of the slot where the group common uplink control information is transmitted.

FIG. 3B illustrates an example of a timeline 302 that supports sidelink COT sharing resource awareness in accordance with aspects of the present disclosure. The timeline 302 may implement or be implemented by aspects of the wireless communications system 100, wireless communications system 200, or both, as described with reference to FIG. 1 and FIG. 2.

A UE may support an FBE mode (e.g., in industrial internet of things (IIoT) environments, in controlled environments with low interference from surrounding signals, such as Wi-Fi signals, or both). In some examples, the UE may support the FBE mode in NR-U for better quality of service (QOS) for ultra-reliable low latency communications, among other communication types. For example, the UE may contend for a channel using Category 2 LBT in accordance with a fixed time grid (e.g., a FFP 320 may be configured to a quantity of time, including an idle period 325, as described herein and a component of the UE may attempt to obtain a COT 330 at the beginning of each FFP 320). In some other examples, a UE may contend for transmission over a channel within a FFP 320 if the UE detects downlink signals or channels (e.g., physical downlink control channel (PDCCH), synchronization signal block (SSB), physical broadcast channel (PBCH), remaining minimum system information (RMSI), group common PDCCH (GC-PDCCH), or the like) within the FFP 320.

The FBE mode may be referred to as semi-static channel access procedures, and the UE may be configured to use semi-static channel access procedures to obtain COT 330, such as by performing LBT procedures in accordance with a FFP 320 configuration. In cases where the UE does not use a Category 4 LBT procedure, channel access times may be associated with lower levels of uncertainty. In some examples, a UE may announce an FBE mode in a RMSI transmission. In some examples, the RMSI transmission may include a configuration for a FFP 320 (e.g., for a channel access opportunity, for COT 330 in the FFP 320, and the like). In some cases, a base station 105 may signal (via RRC signaling, a downlink control information (DCI) message, a MAC control element (MAC-CE), or the like) for the UE to use the FBE mode. In some cases, in a semi-static channel access mode, UE FFP periodicity may be determined from the following set of values in milliseconds (ms): {1, 2, 2.5, 4, 5, 10}. In some cases, an FFP period for UE-initiated COT may be configured as a same, an integer multiple of, or an integer factor of the FFP period configured for base station (e.g., gNB) initiated COT. In some cases, an FFP period for UE-initiated COT may be configured independently from an FFP period of a base station initiated COT (e.g., if the UE indicates a corresponding capability of such). In some cases, an FFP offset for UE-initiated COT may be a starting point of a first UE FFP relative to a radio frame X boundary. For example, an offset value range may be greater than or equal to zero, and less than an FFP period of UE-initiated COT (e.g., 0≤offset<FFP period of UE-initiated COT). In some examples, the starting point of the first UE FFP for a serving cell may be relative to the boundary of the radio frame of an even index number. In some examples, an FFP offset of a UE-initiated COT may be the starting point of a first UE FFP relative to the boundary of the direct frame of an even index number (e.g., frame number.

In some cases, when a base station contends for a channel in a 20 MHz unit, the base station may provide a UE with information including a time and frequency domain span of the current channel occupancy. For frequency domain COT, the base station or the UE may use a bitmap to indicate one or more available LBT bandwidths. The indication of available one or more LBT bandwidths may be valid until an end of the determined channel occupancy (e.g., the current channel occupancy). For time domain COT, the base station or the UE may use a COT duration bit field per serving cell, and may indicate a remaining length or duration from a beginning of a slot that the base station or the UE receives information.

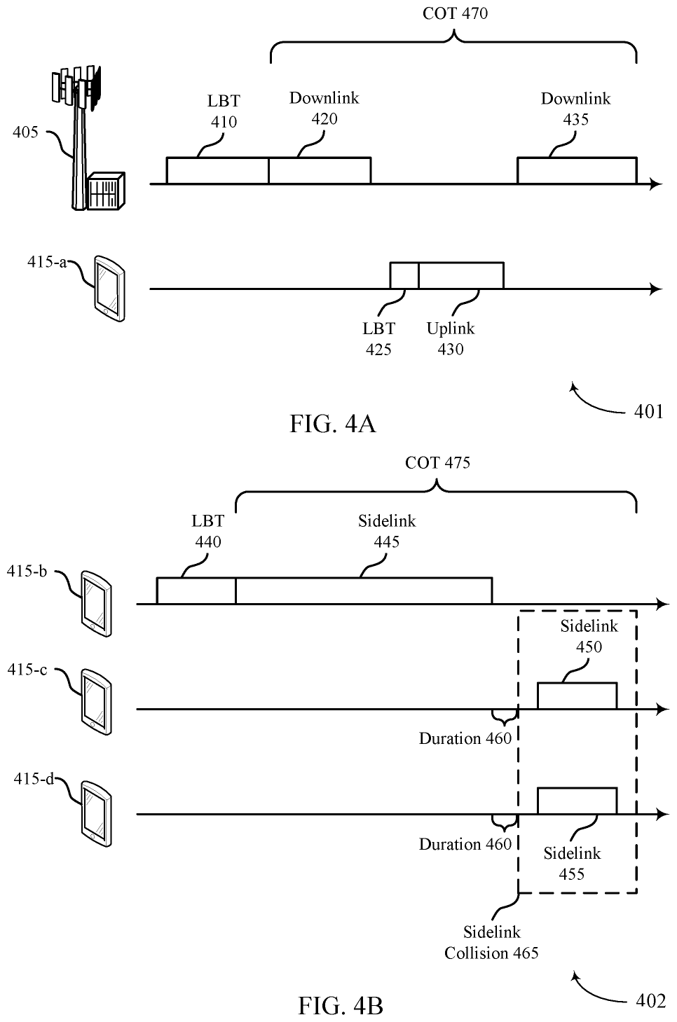

FIG. 4A illustrates an example of a timeline 401 that supports sidelink COT sharing resource awareness in accordance with aspects of the present disclosure. The timeline 401 may implement or be implemented by aspects of the wireless communications system 100, wireless communications system 200, or both, as described with reference to FIG. 1 and FIG. 2. For example, the timeline 401 may depict base station 405, UEs 415, or both, which may be examples of a base station 205, a base station 105, UEs 215, UEs 115, or any other devices, as described herein.

In an unlicensed NR FBE mode, for downlink to uplink COT sharing between base station 405 and UE 415-a, UE 415-a may be able to determine a base station 405 COT structure from a received FFP configuration for base station 405. For unlicensed sidelink communications, UE 415-a (e.g., an FBE UE) has an FFP structure and acquires COT at a beginning of an FFP, and UE 415-a may then be able to share the COT with other sidelink UEs for communication.

UEs 415 may have different FFP configurations (e.g., different FFP periods, different FFP offsets, or both). For example, because different UEs 415 may correspond to different traffic periods, UE 415 FFP periods may be different.

In mode 2 unlicensed sidelink communications (e.g., where base station 405 may not assist or participate in scheduling, and UEs 415 may perform scheduling), UEs 415 may transmit signaling without scheduling from base station 405. However, if UEs 415 have a common UE FFP configuration, collisions in communication may occur. However, it may be difficult for such UEs 415 to be able to determine whether another UE 415 is in an FBE mode, and what the FFP structure of the other UE 415 may be.

In an unlicensed NR FBE mode, base station 405 may control downlink and uplink transmissions, but such control may be unavailable for sidelink cases. Base station may perform an LBT 410 procedure (e.g., a Category 4 LBT) and may transmit signaling to UE 415-a via downlink 420. Base station 405 may share COT 470 with UE 415-a (e.g., via downlink 420, or any other signaling). UE 415-a may perform an LBT 425 (e.g., a Category 2 LBT), and may transmit an uplink transmission to base station 405. Base station 405 may still be able to perform downlink transmission 435 after the uplink transmission 430 without collision as base station 405 may control the scheduling.

FIG. 4B illustrates an example of a timeline 402 that supports sidelink COT sharing resource awareness in accordance with aspects of the present disclosure. The timeline 402 may implement or be implemented by aspects of the wireless communications system 100, wireless communications system 200, or both, as described with reference to FIG. 1 and FIG. 2. For example, the timeline 402 may depict base station 405, UEs 415, or both, which may be examples of a base station 205, a base station 105, UEs 215, UEs 115, or any other devices, as described herein.

As shown in timeline 402, for unlicensed sidelink communications during COT 475, there may be no centralized scheduler (e.g., base station 405). Thus, when a gap from an end of the sidelink 445 transmission (e.g., after UE 415-b performs LBT 440, which may be a Category 4 LBT) to a beginning of another sidelink transmission is up (e.g., less than) to duration 460 (e.g., 16 microseconds), UEs 415 may perform sidelink transmissions (e.g., UE 415-c may perform sidelink 450 transmission, UE 415-d may perform sidelink 455 transmission) without LBT. For example, UEs 415 may share or attempt to share a COT automatically or immediately after receiving another UE 415 COT structure indication (e.g., via sidelink 445 transmission). Such sidelink transmissions may result in a sidelink collision 465.

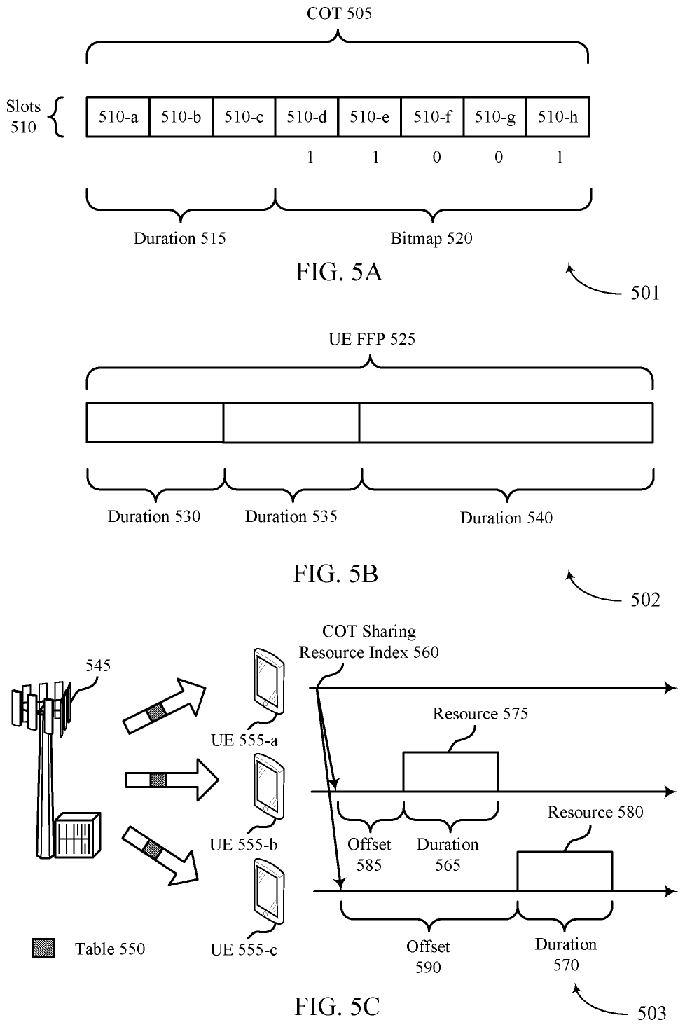

FIG. 5A illustrates an example of a timeline 501 that supports sidelink COT sharing resource awareness in accordance with aspects of the present disclosure. The timeline 501 may implement or be implemented by aspects of the wireless communications system 100, wireless communications system 200, or both, as described with reference to FIG. 1 and FIG. 2.

To avoid transmission collisions, UE may obtain (e.g., receive) other UE FFP configurations from the other UEs, from a base station, or both. For example, the UE may receive an FFP configuration for another UE from the base station. For example, the base station may indicate a UE FFP configuration of the UE to another UE using RRC signaling (e.g., or any other control signaling, such as a DCI message, a MAC-CE, or the like).

In some other examples, the UE may receive a table (e.g., via RRC signaling, or any other control signaling) from the base station with fields {UE ID, UE FFP configuration}, as well as any other fields. In some cases, the UE ID may be a default destination ID or a source ID.

In some other cases, the UE may receive a UE FFP configuration of another UE directly from that UE. For example, each UE may broadcast respective UE FFP configurations to other UEs (e.g., via PC-5 RRC signaling).

In some examples, a base station may configure a table or pre-define a table at a UE that includes a combination (e.g., multiple) UE FFP configurations. The base station may transmit the table to one or more UEs (e.g., via RRC signaling, or any other control signaling). Each UE may be able to broadcast a table index (e.g., corresponding to the UE FFP configuration) to other UEs (e.g., via PC-5 RRC signaling). A UE receiving the table index for another UE may access the table using the table index to determine an FFP configuration (e.g., for the other UE). In some cases, the other UE may relay a different UE FFP configuration to the UE, and thus the UE may receive a table index for a UE different from the UE that transmitted the table index.

In some other examples, a UE may transmit SCI, which may include an SCI format (e.g., SCI format 2-C), for indicating the UE FFP configuration to another UE. In some cases, the SCI format (e.g., SCI format 2-C) may be used only when the UE indicates the FFP configuration to the other UE.

By receiving a UE FFP configuration, a receiving UE may be able to determine the COT structure to reduce sidelink collisions with other UEs.

Additionally or alternatively, to avoid collision among UEs in sidelink COT sharing (e.g., referring at least to timeline 402), a UE (e.g., an initiating UE) may divide the shared COT into different regions and allocate dedicated resources to various sidelink UEs. That is, each UE may be able to transmit sidelink communications during different portions of the set of resources so that conflicts may be avoided. For example, the UE may indicate a set of resources to other UEs that may be shared for a sidelink transmission (e.g., instead of a COT duration.

In some examples, the indication may be different for other UEs. For example, the initiating UE may transmit a COT sharing indication to indicate a COT sharing resource via unicast or groupcast. In some cases, the COT sharing indication may be 1 bit. A value of 0 for the bit may indicate no COT sharing, and 1 may indicate COT sharing, or vice versa. The responding UE may be able to share the COT from an end of the slot where the COT sharing indication is received to the end of the COT.

In some examples (e.g., for both FBE and LBE), the shared resources related to COT 505 may be based on (e.g., with respect to) the indication transmission time (e.g., a UE may transmit the COT sharing indication in slot 510-c, or any other slot). For example, a UE may transmit the indication in the form of a bitmap 520 (e.g., where duration 515 is defined as a duration used by the initiating UE, which may be the UE transmitting the COT sharing indication), or one or more start and length indicator values (SLIVs), or both. In bitmap 520, each bit may explicitly include or exclude a slot (e.g., from COT sharing). In bitmap 520, the first bit (e.g., of value “1”) may correspond to a next slot after the slot where the COT sharing indication may be received (e.g., may correspond to slot 510-d). The UE may transmit the indication using a SLIV, and the indication may be or indicate a starting time or a period and a duration, or a starting slot index and a number of continuous slot indices to be shared.

FIG. 5B illustrates an example of a timeline 502 that supports sidelink COT sharing resource awareness in accordance with aspects of the present disclosure. The timeline 502 may implement or be implemented by aspects of the wireless communications system 100, wireless communications system 200, or both, as described with reference to FIG. 1 and FIG. 2.

In some examples, the shared resources may be based on an FFP structure of the UE indicating the set of resources (e.g., the initiating UE). Offset and duration parameters may be related to UE FFP (e.g., UE FFP 525) (e.g., to reduce signaling overhead). The duration parameter may be defined by a number of slots where sidelink transmissions may be assumed (e.g., a UE or base station may be able to identify such sidelink transmissions) within a UE initiated COT. The offset parameter may indicate a starting slot for a sidelink transmission indicated in a number of slots of a beginning of the FFP. For example, 2 bits in SCI (e.g., SCI-2) may indicate an offset, and corresponding values may be {⅕, ⅖, ⅗, ⅗}. 2 bits in SCI (e.g., SCI-2) may indicate duration, and the corresponding values may be {⅕, ⅖, ⅗, ⅘}. A UE FFP of an initiating UE (e.g., corresponding to duration 530 of 2 slots or 10 slots) may be 5 ms (i.e., 10 slots), and the COT sharing resource for a first responding UE (e.g., corresponding to duration 535 of 2 slots) may be {offset, duration}={00,00}={round(10/5)=2 slots, round(10/5)=2 slots}, and the COT sharing resource for a second responding UE (e.g., corresponding to duration 540 of 6 slots) may be {offset, duration}={01,10}={round(2/5*10)=4 slots, round(3/5*10)=6 slots}.

FIG. 5C illustrates an example of a timeline 503 that supports sidelink COT sharing resource awareness in accordance with aspects of the present disclosure. The timeline 503 may implement or be implemented by aspects of the wireless communications system 100, wireless communications system 200, or both, as described with reference to FIG. 1 and FIG. 2. For example, the timeline 503 may depict base station 545, UEs 555, or both, which may be examples of a base station 205, a base station 105, UEs 215, UEs 115, or any other devices, as described herein.

In some examples, the UE may indicate the set of resources using a received preconfigured table. Base station 545 may configure table 550 for sharing parameters to UEs 555 using control signaling (e.g., RRC signaling). An initiating UE (e.g., UE 555-a) may indicate a COT sharing resource index 560 (e.g., resource 575 and resource 580) to other sidelink UEs 555 via SCI (e.g., SCI-2). In some cases, each row of table 550 may include a duration, an offset, and one row of table 550 may indicate no COT sharing. The duration may indicate a number of slots where sidelink transmissions may be assumed (e.g., a UE or base station may be able to identify such sidelink transmissions) within the UE 555-a initiated COT. For example, table 550 may indicate duration 565 and duration 570 for UE 555-b and UE 555-c, respectively. The offset may indicate a starting slot of sidelink transmission indicated in a number of slots from an end of a slot where UE 555-b or UE 555-c receives the COT sharing resource index 560. For example, table 550 may indicate offset 585 and offset 590 for UE 555-b and UE 555-c, respectively.

If base station 545 does not configure this table to UEs 555 (e.g., where UEs may not share the COT at least for user plane data transmissions), SCI (e.g., SCI-2) may carry a 1 bit COT sharing indication, indicating whether symbol n+X is an applicable symbol for sidelink sharing (e.g., which may only apply for physical sidelink feedback channels (PSFCH)). In such cases, base station 545 may configure X as a part of control signaling (e.g., RRC) configuration, where X may be a number of symbols from an end of a slot where UEs 555 receive the COT sharing indication.

By receiving other UE FFP configurations from the other UEs or a base station, indicating shared resources to other UEs, or both, UEs in unlicensed spectrums communicating using sidelink communication links may reduce transmission conflicts with other transmissions from other UEs.

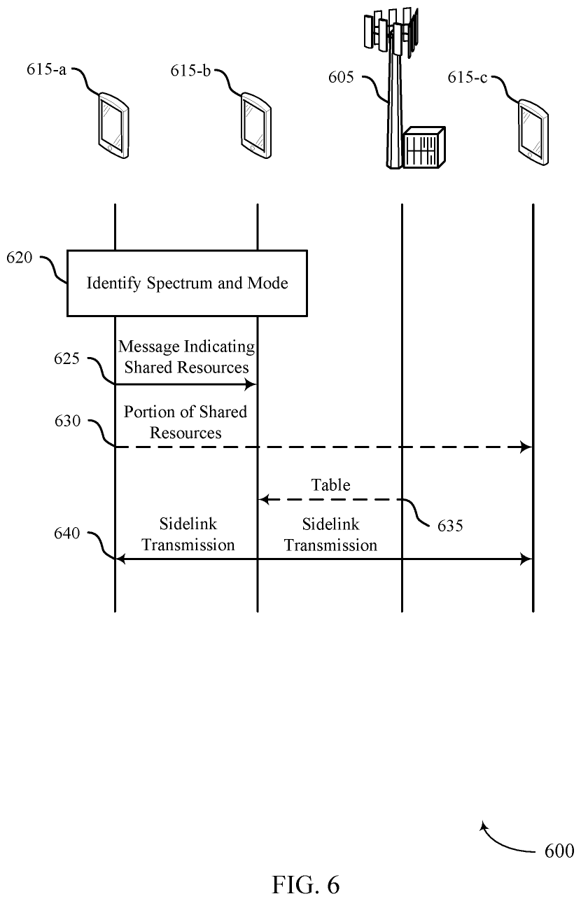

FIG. 6 illustrates an example of a process flow 600 that supports sidelink COT sharing resource awareness in accordance with aspects of the present disclosure. The process flow 600 may implement or be implemented by aspects of the wireless communications system 100, wireless communications system 200, or a combination of these, as described with reference to FIG. 1 and FIG. 2. In some examples, the process flow 600 may include example operations associated with base station 605 and one or more UEs 615, which may be examples of corresponding devices described with reference to FIGS. 1 and 2. In the following description of the process flow 600, the operations between base station 605 and the UEs 615 may be performed in a different order than the example order shown, or the operations performed by the base station and the UEs 615 may be performed in different orders or at different times. Some operations may also be omitted from the process flow 600, and other operations may be added to the process flow 600.

At 620, UE 615-a, UE 615-b, or both, may identify that UE 615-a, UE 615-b, or both, respectively, is operating in an unlicensed spectrum and in an FBE mode or an LBE mode for sidelink communications.

At 625, UE 615-b may receive, from UE 615-a, a message indicating one or more shared resources during a COT, where the one or more shared resources are available for UE 615-b to use for sidelink transmissions. In some examples, UE 615-b may receive, via the message, a single bit that indicates whether UE 615-b is allowed to transmit the sidelink transmission using the one or more shared resources during a duration between when UE 615-b receives the message and an end of the COT. In some examples, UE 615-b may receive the message via unicast. In some examples, the one or more shared resources may be based on a transmission time of the message indicating the one or more shared resources. In some examples, UE 615-b may receive, via the message, a bitmap that indicates the one or more shared resources, where at least one bit of the bitmap indicates a shared resource of the one or more shared resources that is in relation to the transmission time of the message indicating the one or more shared resources. In some examples, UE 615-b may receive, via the message, one or more SLIVs for the one or more shared resources. In some examples, the one or more shared resources may be based on an offset and a duration related to a FFP structure of UE 615-a. In some examples, UE 615-b may receive, from UE 615-a, a shared resource index. UE 615-b may determine the one or more shared resources during the COT based on accessing the table using the shared resource index. In some examples, UE 615-b may receive, from UE 615-a, a single bit resource sharing indication that indicates that a first symbol of the COT is a shared resource. In some examples, the first symbol of the single bit resource sharing indication may represent a first value plus a second value, where the first value is an end of a slot with which UE 615-b receives the single bit resource sharing indication and the second value is a quantity of symbols from the end of the slot with which UE 615-b receives the single bit resource sharing indication. In some examples, UE 615-b may receive the message via groupcast.

At 630, UE 615-b may transmit, to UE 615-c, a second message indicating a second portion of the one or more shared resources during the COT, where the second portion of the one or more shared resources are available for UE 615-c to use for second sidelink transmissions.

At 635, UE 615-b may receive, from base station 605, a table indicating the one or more shared resources.

At 640, UE 615-b may transmit, to UE 615-a, UE 615-c, or both, a sidelink transmission using the one or more shared resources.

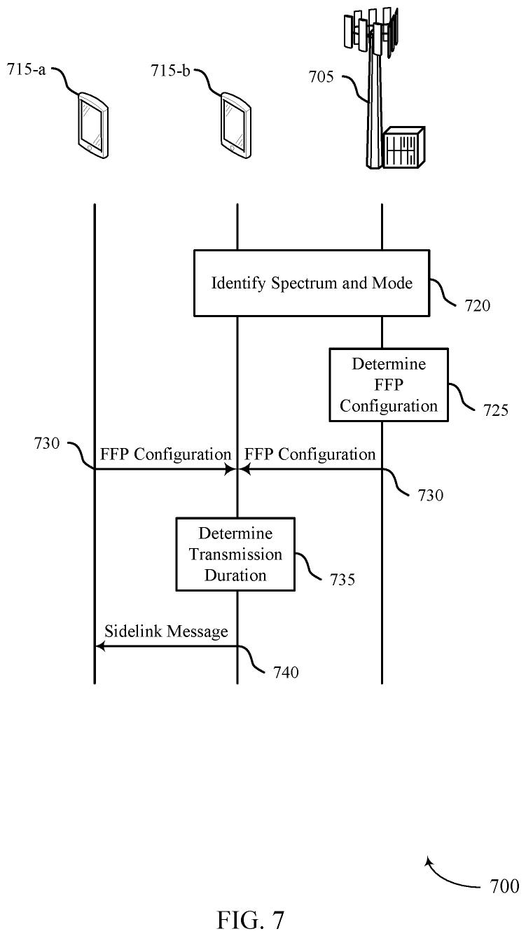

FIG. 7 illustrates an example of a process flow 700 that supports sidelink COT sharing resource awareness in accordance with aspects of the present disclosure. The process flow 700 may implement or be implemented by aspects of the wireless communications system 100, wireless communications system 200, or a combination of these, as described with reference to FIG. 1 and FIG. 2. In some examples, the process flow 700 may include example operations associated with base station 705 and one or more UEs 715, which may be examples of corresponding devices described with reference to FIGS. 1 and 2. In the following description of the process flow 700, the operations between base station 705 and the UEs 715 may be performed in a different order than the example order shown, or the operations performed by the base station and the UEs 715 may be performed in different orders or at different times. Some operations may also be omitted from the process flow 700, and other operations may be added to the process flow 700.

At 720, UE 715-b, base station 705, or both, may identify that UE 715-b, base station 705, or both, respectively, is operating in an unlicensed spectrum and in an FBE mode for sidelink communications.

At 725, base station 705 may determine an FFP configuration for a first wireless device (e.g., UE 715-a), the FFP configuration indicating a period and a time offset for the first wireless device.

At 730, UE 715-b may receive, from UE 715-a, base station 705, or both, an FFP configuration for the first wireless device (e.g., UE 715-a, or another UE), the FFP configuration indicating a period and a time offset for the first wireless device. In some examples, UE 715-b may receive the FFP configuration for the first wireless device from base station 705. In some examples, UE 715-b may receive a table from base station 705, where the table includes the FFP configuration and an identifier of the first wireless device. In some examples, UE 715-b may receive the FFP configuration from UE 715-a, where the FFP configuration is for UE 715-a. In some examples, UE 715-b may receive a table from a base station, where the table includes a plurality of FFP configurations corresponding to a plurality of UEs 715. In some examples, UE 715-b may receive, from UE 715-a, a table index indicating one FFP configuration of the plurality of FFP configurations of the table based on receiving the table from base station 705. In some examples, UE 715-b may receive, from UE 715-a, SCI, the SCI indicating the FFP configuration for UE 715-a.

At 735, UE 715-b may determine a transmission duration for sidelink communications with UE 715-a based on the FFP configuration for the first wireless device.

At 740, UE 715-b may transmit, to UE 715-a, a sidelink message during the transmission duration.

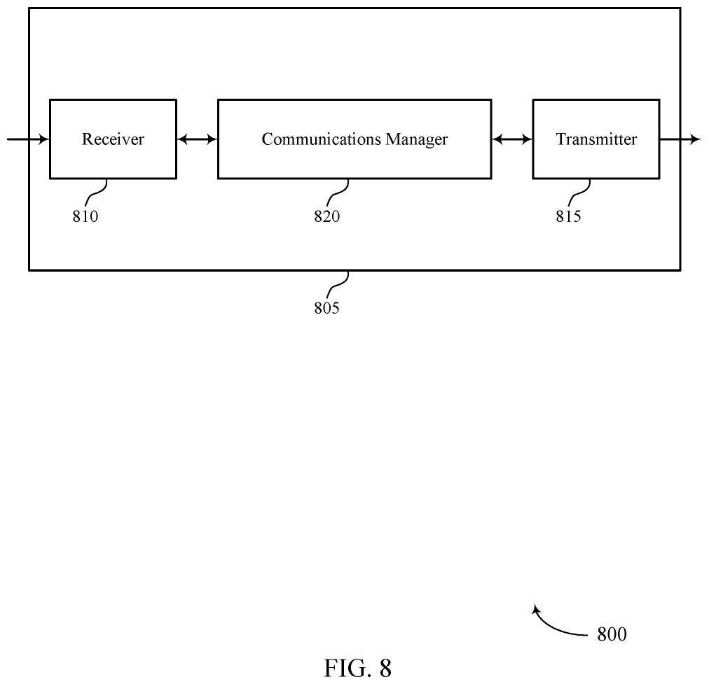

FIG. 8 shows a block diagram 800 of a device 805 that supports sidelink COT sharing resource awareness in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to sidelink COT sharing resource awareness). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to sidelink COT sharing resource awareness). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of sidelink COT sharing resource awareness as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first UE in accordance with examples as disclosed herein. For example, the communications manager 820 may be configured as or otherwise support a means for identifying that the first UE is operating in an unlicensed spectrum and in a FBE mode or a LBE mode for sidelink communications. The communications manager 820 may be configured as or otherwise support a means for receiving, from a second UE, a message indicating one or more shared resources during a COT, where the one or more shared resources are available for the first UE to use for sidelink transmissions. The communications manager 820 may be configured as or otherwise support a means for transmitting, to a third UE, a sidelink transmission using the one or more shared resources.

Additionally or alternatively, the communications manager 820 may support wireless communication at a first UE in accordance with examples as disclosed herein. For example, the communications manager 820 may be configured as or otherwise support a means for identifying that the first UE and a second UE are operating in an unlicensed spectrum and in a FBE mode or a LBE mode for sidelink communications. The communications manager 820 may be configured as or otherwise support a means for transmitting, to the second UE, a first message indicating a first portion of one or more shared resources during a COT, where the first portion of the one or more shared resources are available for the second UE to use for first sidelink transmissions.

Additionally or alternatively, the communications manager 820 may support wireless communication at a first UE in accordance with examples as disclosed herein. For example, the communications manager 820 may be configured as or otherwise support a means for identifying that the first UE is operating in an unlicensed spectrum and in a FBE mode for sidelink communications. The communications manager 820 may be configured as or otherwise support a means for receiving, from a first wireless device, a FFP configuration for a second wireless device, the FFP configuration indicating a period and a time offset for the second wireless device. The communications manager 820 may be configured as or otherwise support a means for determining a transmission duration for sidelink communications with a second UE based on the FFP configuration for the second wireless device. The communications manager 820 may be configured as or otherwise support a means for transmitting, to the second UE, a sidelink message during the transmission duration.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced processing, reduced power consumption, and more efficient utilization of communication resources.

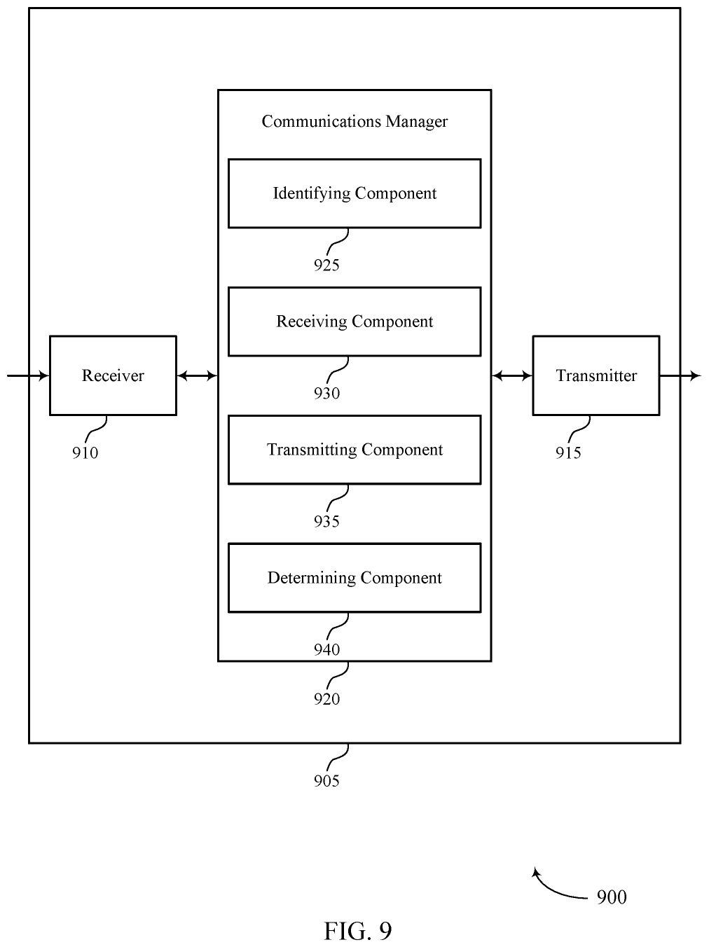

FIG. 9 shows a block diagram 900 of a device 905 that supports sidelink COT sharing resource awareness in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to sidelink COT sharing resource awareness). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to sidelink COT sharing resource awareness). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of sidelink COT sharing resource awareness as described herein. For example, the communications manager 920 may include an identifying component 925, a receiving component 930, a transmitting component 935, a determining component 940, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a first UE in accordance with examples as disclosed herein. The identifying component 925 may be configured as or otherwise support a means for identifying that the first UE is operating in an unlicensed spectrum and in a FBE mode or a LBE mode for sidelink communications. The receiving component 930 may be configured as or otherwise support a means for receiving, from a second UE, a message indicating one or more shared resources during a COT, where the one or more shared resources are available for the first UE to use for sidelink transmissions. The transmitting component 935 may be configured as or otherwise support a means for transmitting, to a third UE, a sidelink transmission using the one or more shared resources.

Additionally or alternatively, the communications manager 920 may support wireless communication at a first UE in accordance with examples as disclosed herein. The identifying component 925 may be configured as or otherwise support a means for identifying that the first UE and a second UE are operating in an unlicensed spectrum and in a FBE mode or a LBE mode for sidelink communications. The transmitting component 935 may be configured as or otherwise support a means for transmitting, to the second UE, a first message indicating a first portion of one or more shared resources during a COT, where the first portion of the one or more shared resources are available for the second UE to use for first sidelink transmissions.

Additionally or alternatively, the communications manager 920 may support wireless communication at a first UE in accordance with examples as disclosed herein. The identifying component 925 may be configured as or otherwise support a means for identifying that the first UE is operating in an unlicensed spectrum and in a FBE mode for sidelink communications. The receiving component 930 may be configured as or otherwise support a means for receiving, from a first wireless device, a FFP configuration for a second wireless device, the FFP configuration indicating a period and a time offset for the second wireless device. The determining component 940 may be configured as or otherwise support a means for determining a transmission duration for sidelink communications with a second UE based on the FFP configuration for the second wireless device. The transmitting component 935 may be configured as or otherwise support a means for transmitting, to the second UE, a sidelink message during the transmission duration.

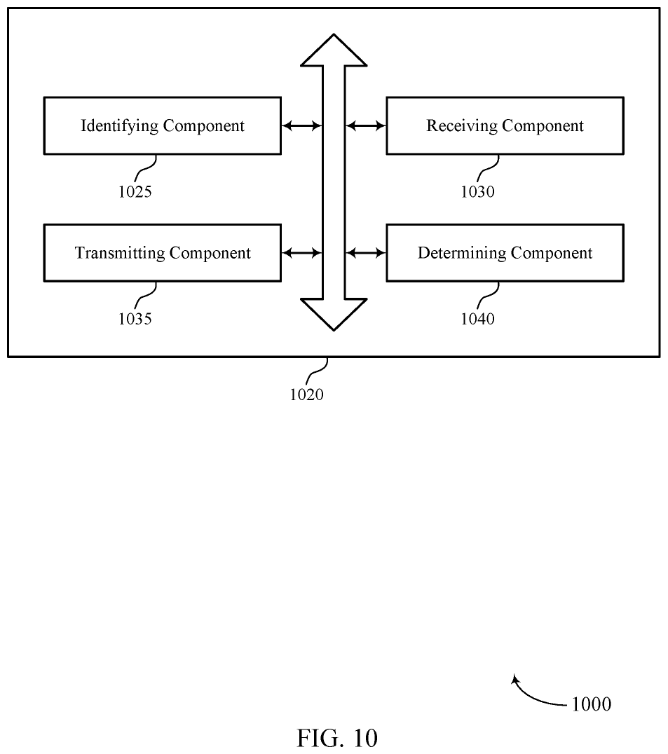

FIG. 10 shows a block diagram 1000 of a communications manager 1020 that supports sidelink COT sharing resource awareness in accordance with aspects of the present disclosure. The communications manager 1020 may be an example of aspects of a communications manager 820, a communications manager 920, or both, as described herein. The communications manager 1020, or various components thereof, may be an example of means for performing various aspects of sidelink COT sharing resource awareness as described herein. For example, the communications manager 1020 may include an identifying component 1025, a receiving component 1030, a transmitting component 1035, a determining component 1040, or any combination thereof. Each of these components may communicate, directly or indirectly, with one another (e.g., via one or more buses).

The communications manager 1020 may support wireless communication at a first UE in accordance with examples as disclosed herein. The identifying component 1025 may be configured as or otherwise support a means for identifying that the first UE is operating in an unlicensed spectrum and in a FBE mode or a LBE mode for sidelink communications. The receiving component 1030 may be configured as or otherwise support a means for receiving, from a second UE, a message indicating one or more shared resources during a COT, where the one or more shared resources are available for the first UE to use for sidelink transmissions. The transmitting component 1035 may be configured as or otherwise support a means for transmitting, to a third UE, a sidelink transmission using the one or more shared resources.

In some examples, to support receiving the message, the receiving component 1030 may be configured as or otherwise support a means for receiving, via the message, a single bit that indicates whether the first UE is allowed to transmit the sidelink transmission using the one or more shared resources during a duration between when the first UE receives the message and an end of the COT.

In some examples, to support receiving the message, the receiving component 1030 may be configured as or otherwise support a means for receiving the message via unicast.

In some examples, the one or more shared resources are based on a transmission time of the message indicating the one or more shared resources.

In some examples, to support receiving the message, the receiving component 1030 may be configured as or otherwise support a means for receiving, via the message, a bitmap that indicates the one or more shared resources, where at least one bit of the bitmap indicates a shared resource of the one or more shared resources that is in relation to the transmission time of the message indicating the one or more shared resources.

In some examples, to support receiving the message, the receiving component 1030 may be configured as or otherwise support a means for receiving, via the message, one or more SLIVs for the one or more shared resources.

In some examples, the one or more shared resources are based on an offset and a duration related to a FFP structure of the second UE.

In some examples, the receiving component 1030 may be configured as or otherwise support a means for receiving, from a base station, a table indicating the one or more shared resources.

In some examples, to support receiving the message, the receiving component 1030 may be configured as or otherwise support a means for receiving, from the second UE, a shared resource index. In some examples, to support receiving the message, the determining component 1040 may be configured as or otherwise support a means for determining the one or more shared resources during the COT based on accessing the table using the shared resource index.

In some examples, to support receiving the message, the receiving component 1030 may be configured as or otherwise support a means for receiving, from the second UE, a single bit resource sharing indication that indicates that a first symbol of the COT is a shared resource.

In some examples, the first symbol of the single bit resource sharing indication represents a first value plus a second value. In some examples, the first value is an end of a slot with which the first UE receives the single bit resource sharing indication and the second value is a quantity of symbols from the end of the slot with which the first UE receives the single bit resource sharing indication.

In some examples, to support receiving the message, the receiving component 1030 may be configured as or otherwise support a means for receiving the message via groupcast.

Additionally or alternatively, the communications manager 1020 may support wireless communication at a first UE in accordance with examples as disclosed herein. In some examples, the identifying component 1025 may be configured as or otherwise support a means for identifying that the first UE and a second UE are operating in an unlicensed spectrum and in a FBE mode or a LBE mode for sidelink communications. In some examples, the transmitting component 1035 may be configured as or otherwise support a means for transmitting, to the second UE, a first message indicating a first portion of one or more shared resources during a COT, where the first portion of the one or more shared resources are available for the second UE to use for first sidelink transmissions.

In some examples, to support transmitting the first message, the transmitting component 1035 may be configured as or otherwise support a means for transmitting, to a third UE, a second message indicating a second portion of the one or more shared resources during the COT, where the second portion of the one or more shared resources are available for the third UE to use for second sidelink transmissions.

In some examples, to support transmitting the first message, the transmitting component 1035 may be configured as or otherwise support a means for transmitting, via the first message, a single bit that indicates whether the second UE is allowed to transmit the first sidelink transmissions using the first portion of the one or more shared resources during a duration between when the second UE receives the first message and an end of the COT.

In some examples, to support transmitting the first message, the transmitting component 1035 may be configured as or otherwise support a means for transmitting the first message to the second UE via unicast.

In some examples, the one or more shared resources are based on a transmission time of the first message indicating the one or more shared resources.

In some examples, to support transmitting the first message, the transmitting component 1035 may be configured as or otherwise support a means for transmitting, via the first message, a bitmap that indicates the one or more shared resources, where at least one bit of the bitmap indicates a shared resource of the one or more shared resources that is in relation to the transmission time of the first message indicating the one or more shared resources.

In some examples, to support transmitting the first message, the transmitting component 1035 may be configured as or otherwise support a means for transmitting, via the first message, one or more SLIVs for the one or more shared resources.

In some examples, the one or more shared resources are based on an offset and a duration related to a FFP structure of the first UE.

Additionally or alternatively, the communications manager 1020 may support wireless communication at a first UE in accordance with examples as disclosed herein. In some examples, the identifying component 1025 may be configured as or otherwise support a means for identifying that the first UE is operating in an unlicensed spectrum and in a FBE mode for sidelink communications. In some examples, the receiving component 1030 may be configured as or otherwise support a means for receiving, from a first wireless device, a FFP configuration for a second wireless device, the FFP configuration indicating a period and a time offset for the second wireless device. The determining component 1040 may be configured as or otherwise support a means for determining a transmission duration for sidelink communications with a second UE based on the FFP configuration for the second wireless device. In some examples, the transmitting component 1035 may be configured as or otherwise support a means for transmitting, to the second UE, a sidelink message during the transmission duration.

In some examples, to support receiving the FFP configuration, the receiving component 1030 may be configured as or otherwise support a means for receiving the FFP configuration for the second wireless device from a base station.

In some examples, to support receiving the FFP configuration, the receiving component 1030 may be configured as or otherwise support a means for receiving a table from the base station, where the table includes the FFP configuration and an identifier of the second wireless device.

In some examples, to support receiving the FFP configuration, the receiving component 1030 may be configured as or otherwise support a means for receiving the FFP configuration from the second UE, where the FFP configuration is for the second UE.

In some examples, to support receiving the FFP configuration, the receiving component 1030 may be configured as or otherwise support a means for receiving a table from a base station, where the table includes a set of multiple FFP configurations corresponding to a set of multiple UEs.

In some examples, to support receiving the FFP configuration, the receiving component 1030 may be configured as or otherwise support a means for receiving, from the second UE, a table index indicating one FFP configuration of the set of multiple FFP configurations of the table based on receiving the table from the base station.

In some examples, to support receiving the FFP configuration, the receiving component 1030 may be configured as or otherwise support a means for receiving, from the second UE, SCI, the SCI indicating the FFP configuration for the second UE.

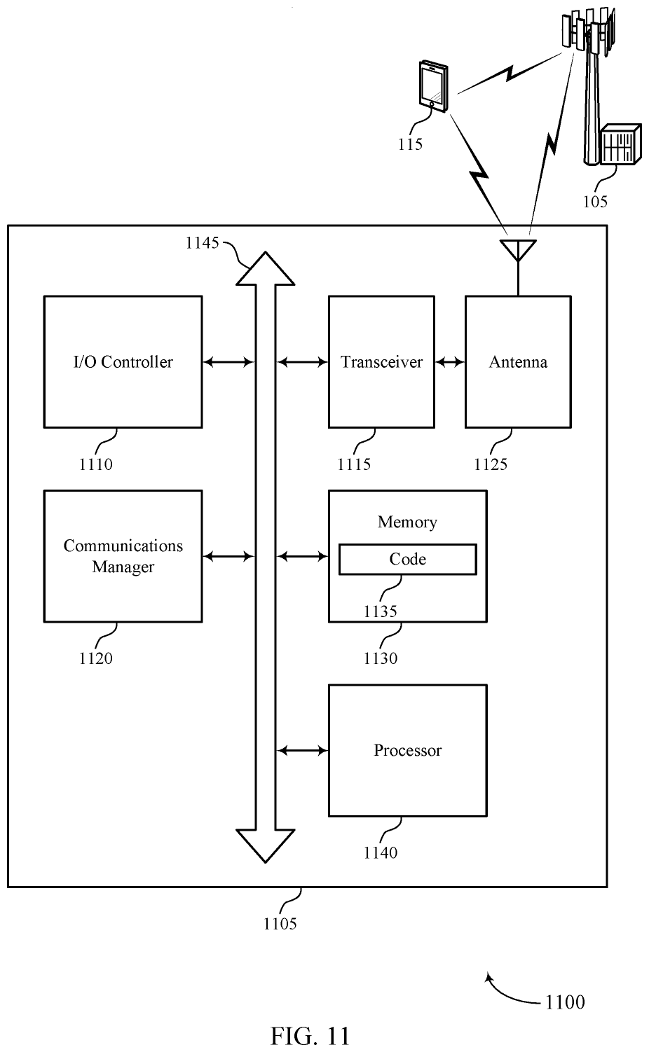

FIG. 11 shows a diagram of a system 1100 including a device 1105 that supports sidelink COT sharing resource awareness in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting sidelink COT sharing resource awareness). For example, the device 1105 or a component of the device 1105 may include a processor 1140 and memory 1130 coupled to the processor 1140, the processor 1140 and memory 1130 configured to perform various functions described herein.

The communications manager 1120 may support wireless communication at a first UE in accordance with examples as disclosed herein. For example, the communications manager 1120 may be configured as or otherwise support a means for identifying that the first UE is operating in an unlicensed spectrum and in a FBE mode or a LBE mode for sidelink communications. The communications manager 1120 may be configured as or otherwise support a means for receiving, from a second UE, a message indicating one or more shared resources during a COT, where the one or more shared resources are available for the first UE to use for sidelink transmissions. The communications manager 1120 may be configured as or otherwise support a means for transmitting, to a third UE, a sidelink transmission using the one or more shared resources.

Additionally or alternatively, the communications manager 1120 may support wireless communication at a first UE in accordance with examples as disclosed herein. For example, the communications manager 1120 may be configured as or otherwise support a means for identifying that the first UE and a second UE are operating in an unlicensed spectrum and in a FBE mode or a LBE mode for sidelink communications. The communications manager 1120 may be configured as or otherwise support a means for transmitting, to the second UE, a first message indicating a first portion of one or more shared resources during a COT, where the first portion of the one or more shared resources are available for the second UE to use for first sidelink transmissions.

Additionally or alternatively, the communications manager 1120 may support wireless communication at a first UE in accordance with examples as disclosed herein. For example, the communications manager 1120 may be configured as or otherwise support a means for identifying that the first UE is operating in an unlicensed spectrum and in a FBE mode for sidelink communications. The communications manager 1120 may be configured as or otherwise support a means for receiving, from a first wireless device, a FFP configuration for a second wireless device, the FFP configuration indicating a period and a time offset for the second wireless device. The communications manager 1120 may be configured as or otherwise support a means for determining a transmission duration for sidelink communications with a second UE based on the FFP configuration for the second wireless device. The communications manager 1120 may be configured as or otherwise support a means for transmitting, to the second UE, a sidelink message during the transmission duration.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of sidelink COT sharing resource awareness as described herein, or the processor 1140 and the memory 1130 may be otherwise configured to perform or support such operations.

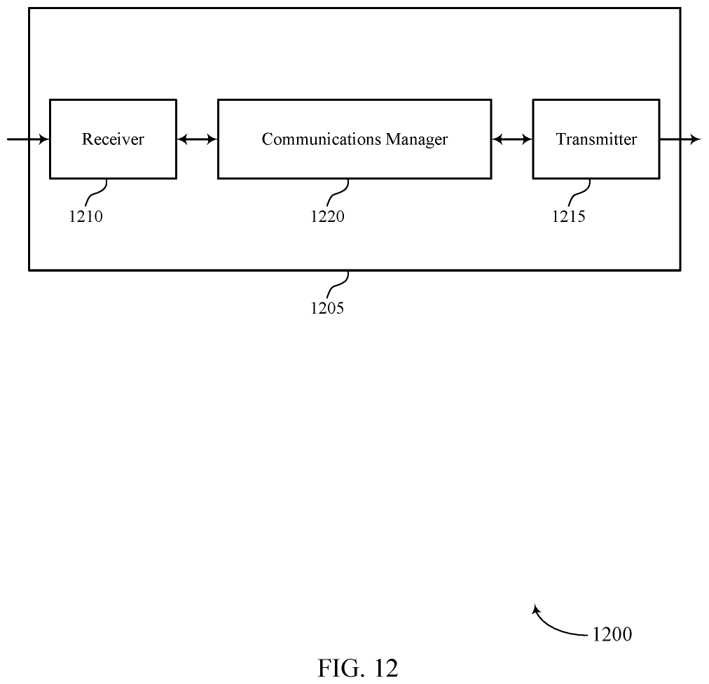

FIG. 12 shows a block diagram 1200 of a device 1205 that supports sidelink COT sharing resource awareness in accordance with aspects of the present disclosure. The device 1205 may be an example of aspects of a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to sidelink COT sharing resource awareness). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to sidelink COT sharing resource awareness). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of sidelink COT sharing resource awareness as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a base station in accordance with examples as disclosed herein. For example, the communications manager 1220 may be configured as or otherwise support a means for identifying that a first UE is operating in an unlicensed spectrum and in a FBE mode for sidelink communications. The communications manager 1220 may be configured as or otherwise support a means for determining a FFP configuration for a first wireless device, the FFP configuration indicating a period and a time offset for the first wireless device. The communications manager 1220 may be configured as or otherwise support a means for transmitting, to the first UE, the FFP configuration for the first wireless device.

By including or configuring the communications manager 1220 in accordance with examples as described herein, the device 1205 (e.g., a processor controlling or otherwise coupled to the receiver 1210, the transmitter 1215, the communications manager 1220, or a combination thereof) may support techniques for reduced processing, reduced power consumption, and more efficient utilization of communication resources.

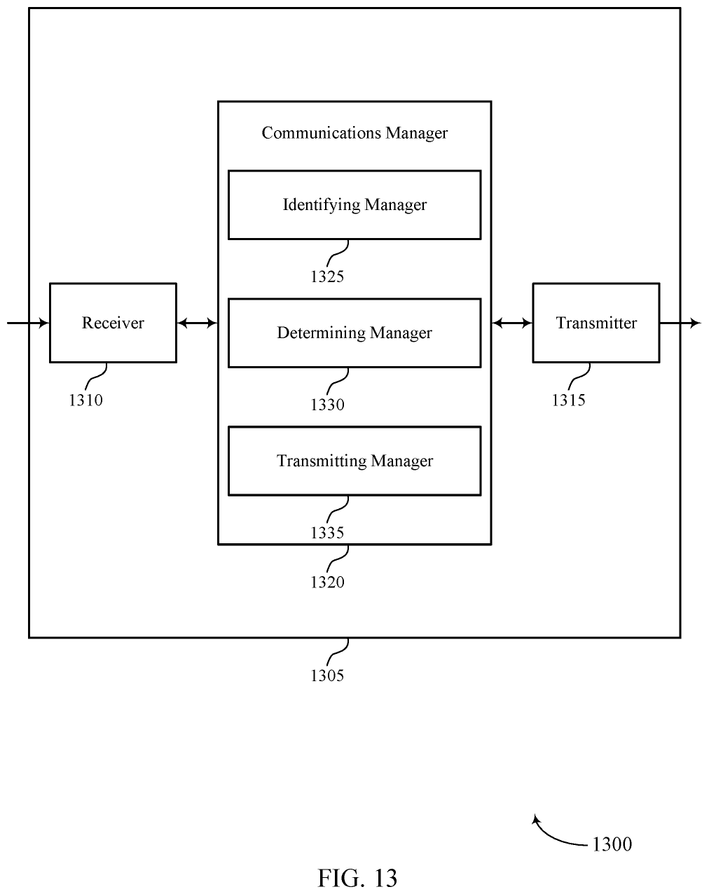

FIG. 13 shows a block diagram 1300 of a device 1305 that supports sidelink COT sharing resource awareness in accordance with aspects of the present disclosure. The device 1305 may be an example of aspects of a device 1205 or a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to sidelink COT sharing resource awareness). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to sidelink COT sharing resource awareness). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of sidelink COT sharing resource awareness as described herein. For example, the communications manager 1320 may include an identifying manager 1325, a determining manager 1330, a transmitting manager 1335, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communication at a base station in accordance with examples as disclosed herein. The identifying manager 1325 may be configured as or otherwise support a means for identifying that a first UE is operating in an unlicensed spectrum and in a FBE mode for sidelink communications. The determining manager 1330 may be configured as or otherwise support a means for determining a FFP configuration for a first wireless device, the FFP configuration indicating a period and a time offset for the first wireless device. The transmitting manager 1335 may be configured as or otherwise support a means for transmitting, to the first UE, the FFP configuration for the first wireless device.

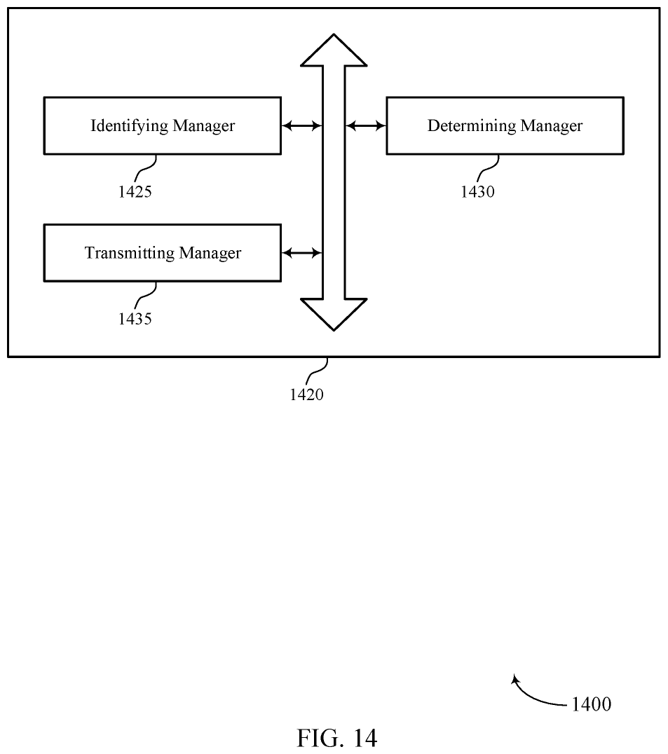

FIG. 14 shows a block diagram 1400 of a communications manager 1420 that supports sidelink COT sharing resource awareness in accordance with aspects of the present disclosure. The communications manager 1420 may be an example of aspects of a communications manager 1220, a communications manager 1320, or both, as described herein. The communications manager 1420, or various components thereof, may be an example of means for performing various aspects of sidelink COT sharing resource awareness as described herein. For example, the communications manager 1420 may include an identifying manager 1425, a determining manager 1430, a transmitting manager 1435, or any combination thereof. Each of these components may communicate, directly or indirectly, with one another (e.g., via one or more buses).

The communications manager 1420 may support wireless communication at a base station in accordance with examples as disclosed herein. The identifying manager 1425 may be configured as or otherwise support a means for identifying that a first UE is operating in an unlicensed spectrum and in a FBE mode for sidelink communications. The determining manager 1430 may be configured as or otherwise support a means for determining a FFP configuration for a first wireless device, the FFP configuration indicating a period and a time offset for the first wireless device. The transmitting manager 1435 may be configured as or otherwise support a means for transmitting, to the first UE, the FFP configuration for the first wireless device.

In some examples, to support transmitting the FFP configuration, the transmitting manager 1435 may be configured as or otherwise support a means for transmitting a table to the first UE, where the table includes the FFP configuration for the first wireless device and an identifier of the first wireless device.

In some examples, to support transmitting the FFP configuration, the transmitting manager 1435 may be configured as or otherwise support a means for transmitting a table to the first UE, where the table includes a set of multiple FFP configurations corresponding to a set of multiple UEs.

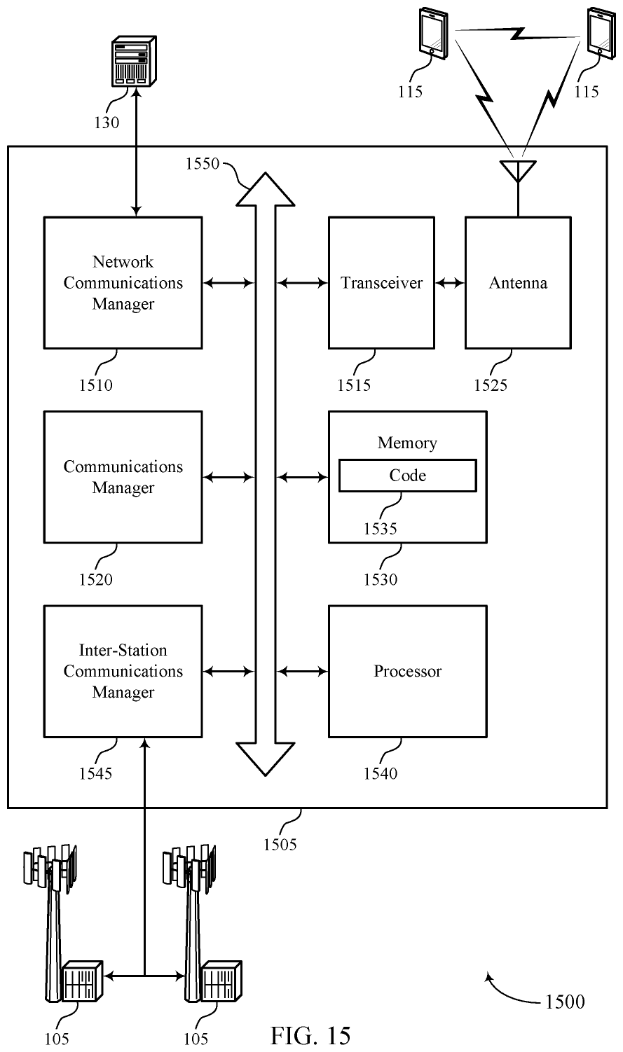

FIG. 15 shows a diagram of a system 1500 including a device 1505 that supports sidelink COT sharing resource awareness in accordance with aspects of the present disclosure. The device 1505 may be an example of or include the components of a device 1205, a device 1305, or a base station 105 as described herein. The device 1505 may communicate wirelessly with one or more base stations 105, UEs 115, or any combination thereof. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-station communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network 130 (e.g., via one or more wired backhaul links). For example, the network communications manager 1510 may manage the transfer of data communications for client devices, such as one or more UEs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a BIOS which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting sidelink COT sharing resource awareness). For example, the device 1505 or a component of the device 1505 may include a processor 1540 and memory 1530 coupled to the processor 1540, the processor 1540 and memory 1530 configured to perform various functions described herein.

The inter-station communications manager 1545 may manage communications with other base stations 105, and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communications network technology to provide communication between base stations 105.

The communications manager 1520 may support wireless communication at a base station in accordance with examples as disclosed herein. For example, the communications manager 1520 may be configured as or otherwise support a means for identifying that a first UE is operating in an unlicensed spectrum and in a FBE mode for sidelink communications. The communications manager 1520 may be configured as or otherwise support a means for determining a FFP configuration for a first wireless device, the FFP configuration indicating a period and a time offset for the first wireless device. The communications manager 1520 may be configured as or otherwise support a means for transmitting, to the first UE, the FFP configuration for the first wireless device.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of sidelink COT sharing resource awareness as described herein, or the processor 1540 and the memory 1530 may be otherwise configured to perform or support such operations.

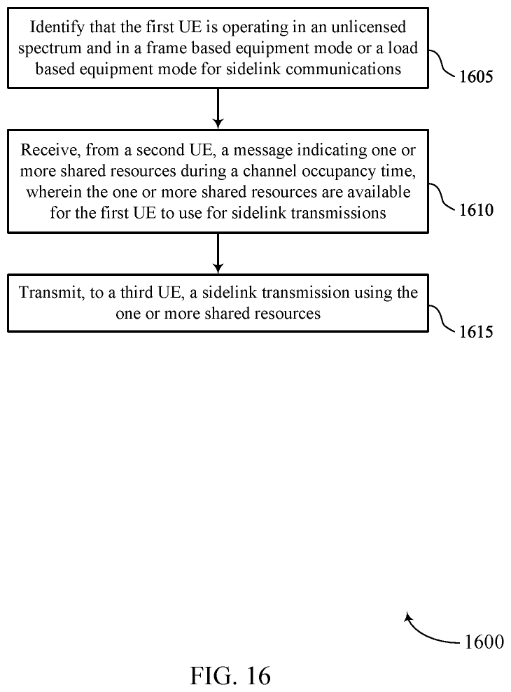

FIG. 16 shows a flowchart illustrating a method 1600 that supports sidelink COT sharing resource awareness in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1605, the method may include identifying that the first UE is operating in an unlicensed spectrum and in a FBE mode or a LBE mode for sidelink communications. The operations of 1605 may be performed in accordance with examples as disclosed herein. In some examples, aspects of the operations of 1605 may be performed by an identifying component 1025 as described with reference to FIG. 10.

At 1610, the method may include receiving, from a second UE, a message indicating one or more shared resources during a COT, where the one or more shared resources are available for the first UE to use for sidelink transmissions. The operations of 1610 may be performed in accordance with examples as disclosed herein. In some examples, aspects of the operations of 1610 may be performed by a receiving component 1030 as described with reference to FIG. 10.

At 1615, the method may include transmitting, to a third UE, a sidelink transmission using the one or more shared resources. The operations of 1615 may be performed in accordance with examples as disclosed herein. In some examples, aspects of the operations of 1615 may be performed by a transmitting component 1035 as described with reference to FIG. 10.

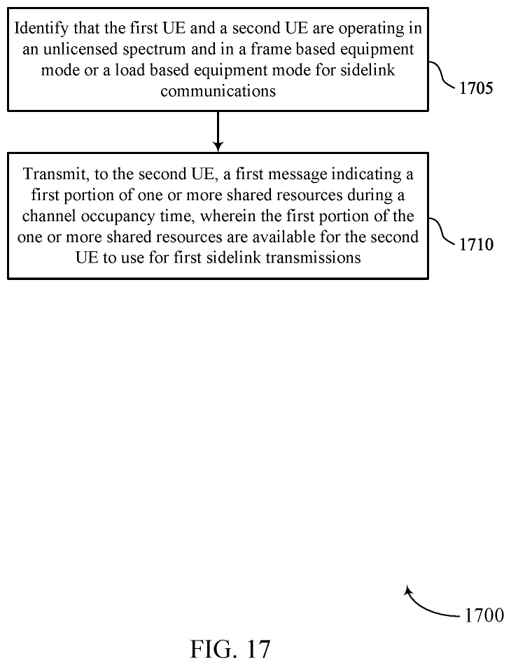

FIG. 17 shows a flowchart illustrating a method 1700 that supports sidelink COT sharing resource awareness in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1705, the method may include identifying that the first UE and a second UE are operating in an unlicensed spectrum and in a FBE mode or a LBE mode for sidelink communications. The operations of 1705 may be performed in accordance with examples as disclosed herein. In some examples, aspects of the operations of 1705 may be performed by an identifying component 1025 as described with reference to FIG. 10.

At 1710, the method may include transmitting, to the second UE, a first message indicating a first portion of one or more shared resources during a COT, where the first portion of the one or more shared resources are available for the second UE to use for first sidelink transmissions. The operations of 1710 may be performed in accordance with examples as disclosed herein. In some examples, aspects of the operations of 1710 may be performed by a transmitting component 1035 as described with reference to FIG. 10.

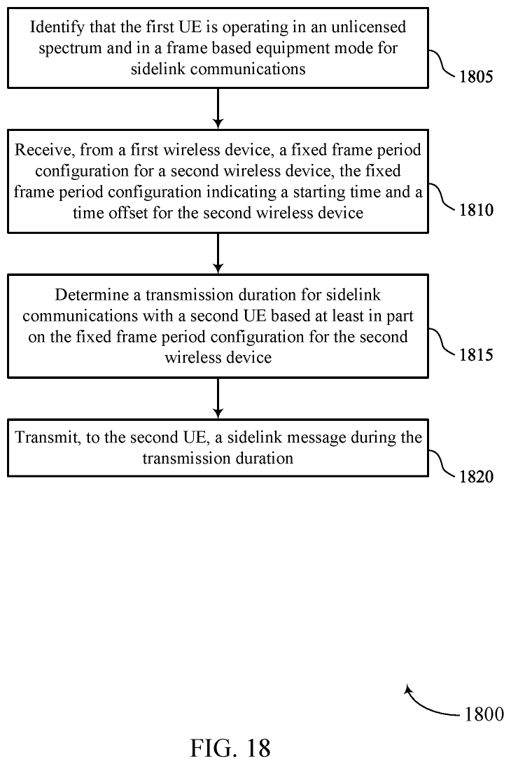

FIG. 18 shows a flowchart illustrating a method 1800 that supports sidelink COT sharing resource awareness in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1805, the method may include identifying that the first UE is operating in an unlicensed spectrum and in a FBE mode for sidelink communications. The operations of 1805 may be performed in accordance with examples as disclosed herein. In some examples, aspects of the operations of 1805 may be performed by an identifying component 1025 as described with reference to FIG. 10.

At 1810, the method may include receiving, from a first wireless device, a FFP configuration for a second wireless device, the FFP configuration indicating a period and a time offset for the second wireless device. The operations of 1810 may be performed in accordance with examples as disclosed herein. In some examples, aspects of the operations of 1810 may be performed by a receiving component 1030 as described with reference to FIG. 10.

At 1815, the method may include determining a transmission duration for sidelink communications with a second UE based on the FFP configuration for the second wireless device. The operations of 1815 may be performed in accordance with examples as disclosed herein. In some examples, aspects of the operations of 1815 may be performed by a determining component 1040 as described with reference to FIG. 10.

At 1820, the method may include transmitting, to the second UE, a sidelink message during the transmission duration. The operations of 1820 may be performed in accordance with examples as disclosed herein. In some examples, aspects of the operations of 1820 may be performed by a transmitting component 1035 as described with reference to FIG. 10.

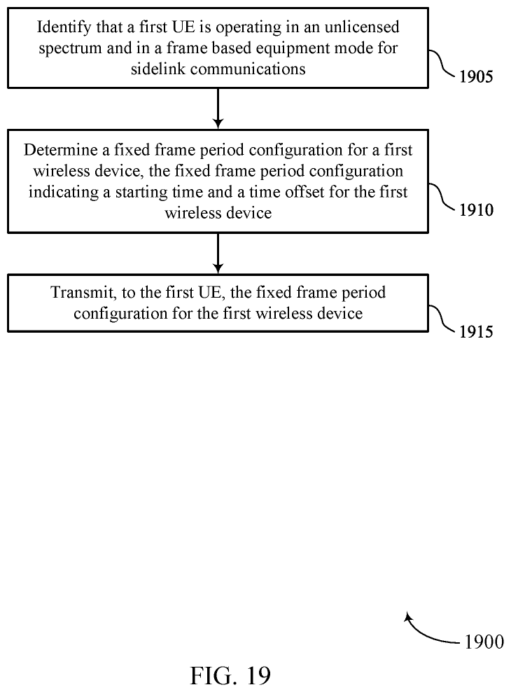

FIG. 19 shows a flowchart illustrating a method 1900 that supports sidelink COT sharing resource awareness in accordance with aspects of the present disclosure. The operations of the method 1900 may be implemented by a base station or its components as described herein. For example, the operations of the method 1900 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 1905, the method may include identifying that a first UE is operating in an unlicensed spectrum and in a FBE mode for sidelink communications. The operations of 1905 may be performed in accordance with examples as disclosed herein. In some examples, aspects of the operations of 1905 may be performed by an identifying manager 1425 as described with reference to FIG. 14.

At 1910, the method may include determining a FFP configuration for a first wireless device, the FFP configuration indicating a period and a time offset for the first wireless device. The operations of 1910 may be performed in accordance with examples as disclosed herein. In some examples, aspects of the operations of 1910 may be performed by a determining manager 1430 as described with reference to FIG. 14.

At 1915, the method may include transmitting, to the first UE, the FFP configuration for the first wireless device. The operations of 1915 may be performed in accordance with examples as disclosed herein. In some examples, aspects of the operations of 1915 may be performed by a transmitting manager 1435 as described with reference to FIG. 14.

The following provides an overview of aspects of the present disclosure:

Aspect 1: A method for wireless communication at a first UE, comprising: identifying that the first UE is operating in an unlicensed spectrum and in a FBE mode or a LBE mode for sidelink communications; receiving, from a second UE, a message indicating one or more shared resources during a COT, wherein the one or more shared resources are available for the first UE to use for sidelink transmissions; and transmitting, to a third UE, a sidelink transmission using the one or more shared resources.

Aspect 2: The method of aspect 1, wherein receiving the message further comprises: receiving, via the message, a single bit that indicates whether the first UE is allowed to transmit the sidelink transmission using the one or more shared resources during a duration between when the first UE receives the message and an end of the COT.

Aspect 3: The method of aspect 2, wherein receiving the message further comprises: receiving the message via unicast.

Aspect 4: The method of any of aspects 1 through 3, wherein the one or more shared resources are based at least in part on a transmission time of the message indicating the one or more shared resources.

Aspect 5: The method of aspect 4, wherein receiving the message further comprises: receiving, via the message, a bitmap that indicates the one or more shared resources, wherein at least one bit of the bitmap indicates a shared resource of the one or more shared resources that is in relation to the transmission time of the message indicating the one or more shared resources.

Aspect 6: The method of any of aspects 4 through 5, wherein receiving the message further comprises: receiving, via the message, one or more SLIVs for the one or more shared resources.

Aspect 7: The method of any of aspects 1 through 6, wherein the one or more shared resources are based at least in part on an offset and a duration related to a FFP structure of the second UE.

Aspect 8: The method of any of aspects 1 through 7, further comprising: receiving, from a base station, a table indicating the one or more shared resources.

Aspect 9: The method of aspect 8, wherein receiving the message further comprises: receiving, from the second UE, a shared resource index; and determining the one or more shared resources during the COT based at least in part on accessing the table using the shared resource index.

Aspect 10: The method of any of aspects 8 through 9, wherein receiving the message further comprises: receiving, from the second UE, a single bit resource sharing indication that indicates that a first symbol of the COT is a shared resource.

Aspect 11: The method of aspect 10, wherein the first symbol of the single bit resource sharing indication represents a first value plus a second value, the first value is an end of a slot with which the first UE receives the single bit resource sharing indication and the second value is a quantity of symbols from the end of the slot with which the first UE receives the single bit resource sharing indication.

Aspect 12: The method of any of aspects 1 through 11, wherein receiving the message further comprises: receiving the message via groupcast.

Aspect 13: A method for wireless communication at a first UE, comprising: identifying that the first UE and a second UE are operating in an unlicensed spectrum and in a FBE mode or a LBE mode for sidelink communications; and transmitting, to the second UE, a first message indicating a first portion of one or more shared resources during a COT, wherein the first portion of the one or more shared resources are available for the second UE to use for first sidelink transmissions.

Aspect 14: The method of aspect 13, wherein transmitting the first message further comprises: transmitting, to a third UE, a second message indicating a second portion of the one or more shared resources during the COT, wherein the second portion of the one or more shared resources are available for the third UE to use for second sidelink transmissions.

Aspect 15: The method of any of aspects 13 through 14, wherein transmitting the first message further comprises: transmitting, via the first message, a single bit that indicates whether the second UE is allowed to transmit the first sidelink transmissions using the first portion of the one or more shared resources during a duration between when the second UE receives the first message and an end of the COT.

Aspect 16: The method of aspect 15, wherein transmitting the first message further comprises: transmitting the first message to the second UE via unicast.

Aspect 17: The method of any of aspects 13 through 16, wherein the one or more shared resources are based at least in part on a transmission time of the first message indicating the one or more shared resources.

Aspect 18: The method of aspect 17, wherein transmitting the first message further comprises: transmitting, via the first message, a bitmap that indicates the one or more shared resources, wherein at least one bit of the bitmap indicates a shared resource of the one or more shared resources that is in relation to the transmission time of the first message indicating the one or more shared resources.

Aspect 19: The method of any of aspects 17 through 18, wherein transmitting the first message further comprises: transmitting, via the first message, one or more SLIVs for the one or more shared resources.

Aspect 20: The method of any of aspects 13 through 19, wherein the one or more shared resources are based at least in part on an offset and a duration related to a FFP structure of the first UE.

Aspect 21: A method for wireless communication at a first UE, comprising: identifying that the first UE is operating in an unlicensed spectrum and in a FBE mode for sidelink communications; receiving, from a first wireless device, a FFP configuration for a second wireless device, the FFP configuration indicating a period and a time offset for the second wireless device; determining a transmission duration for sidelink communications with a second UE based at least in part on the FFP configuration for the second wireless device; and transmitting, to the second UE, a sidelink message during the transmission duration.

Aspect 22: The method of aspect 21, wherein receiving the FFP configuration further comprises: receiving the FFP configuration for the second wireless device from a base station.

Aspect 23: The method of aspect 22, wherein receiving the FFP configuration further comprises: receiving a table from the base station, wherein the table includes the FFP configuration and an identifier of the second wireless device.

Aspect 24: The method of any of aspects 21 through 23, wherein receiving the FFP configuration further comprises: receiving the FFP configuration from the second UE, wherein the FFP configuration is for the second UE.

Aspect 25: The method of any of aspects 21 through 24, wherein receiving the FFP configuration further comprises: receiving a table from a base station, wherein the table includes a plurality of FFP configurations corresponding to a plurality of UEs.

Aspect 26: The method of aspect 25, wherein receiving the FFP configuration further comprises: receiving, from the second UE, a table index indicating one FFP configuration of the plurality of FFP configurations of the table based at least in part on receiving the table from the base station.

Aspect 27: The method of any of aspects 21 through 26, wherein receiving the FFP configuration further comprises: receiving, from the second UE, SCI, the SCI indicating the FFP configuration for the second UE.

Aspect 28: A method for wireless communication at a base station, comprising: identifying that a first UE is operating in an unlicensed spectrum and in a FBE mode for sidelink communications; determining a FFP configuration for a first wireless device, the FFP configuration indicating a period and a time offset for the first wireless device; and transmitting, to the first UE, the FFP configuration for the first wireless device.

Aspect 29: The method of aspect 28, wherein transmitting the FFP configuration further comprises: transmitting a table to the first UE, wherein the table includes the FFP configuration for the first wireless device and an identifier of the first wireless device.

Aspect 30: The method of any of aspects 28 through 29, wherein transmitting the FFP configuration further comprises: transmitting a table to the first UE, wherein the table includes a plurality of FFP configurations corresponding to a plurality of UEs.

Aspect 31: An apparatus for wireless communication at a first UE, comprising a processor; memory coupled with the processor; and instructions stored in the memory and executable by the processor to cause the apparatus to perform a method of any of aspects 1 through 12.

Aspect 32: An apparatus for wireless communication at a first UE, comprising at least one means for performing a method of any of aspects 1 through 12.

Aspect 33: A non-transitory computer-readable medium storing code for wireless communication at a first UE, the code comprising instructions executable by a processor to perform a method of any of aspects 1 through 12.

Aspect 34: An apparatus for wireless communication at a first UE, comprising a processor; memory coupled with the processor; and instructions stored in the memory and executable by the processor to cause the apparatus to perform a method of any of aspects 13 through 20.

Aspect 35: An apparatus for wireless communication at a first UE, comprising at least one means for performing a method of any of aspects 13 through 20.

Aspect 36: A non-transitory computer-readable medium storing code for wireless communication at a first UE, the code comprising instructions executable by a processor to perform a method of any of aspects 13 through 20.

Aspect 37: An apparatus for wireless communication at a first UE, comprising a processor; memory coupled with the processor; and instructions stored in the memory and executable by the processor to cause the apparatus to perform a method of any of aspects 21 through 27.

Aspect 38: An apparatus for wireless communication at a first UE, comprising at least one means for performing a method of any of aspects 21 through 27.

Aspect 39: A non-transitory computer-readable medium storing code for wireless communication at a first UE, the code comprising instructions executable by a processor to perform a method of any of aspects 21 through 27.

Aspect 40: An apparatus for wireless communication at a base station, comprising a processor; memory coupled with the processor; and instructions stored in the memory and executable by the processor to cause the apparatus to perform a method of any of aspects 28 through 30.

Aspect 41: An apparatus for wireless communication at a base station, comprising at least one means for performing a method of any of aspects 28 through 30.

Aspect 42: A non-transitory computer-readable medium storing code for wireless communication at a base station, the code comprising instructions executable by a processor to perform a method of any of aspects 28 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
identifying that the first UE is operating in an unlicensed spectrum and in a frame based equipment mode or a load based equipment mode for sidelink communications;
receiving, from a second UE, a message indicating one or more shared resources during a channel occupancy time, wherein the one or more shared resources are available for the first UE to use for sidelink transmissions; and
transmitting, to a third UE, a sidelink transmission using the one or more shared resources.

2. The method of claim 1, wherein receiving the message further comprises:
receiving, via the message, a single bit that indicates whether the first UE is allowed to transmit the sidelink transmission using the one or more shared resources during a duration between when the first UE receives the message and an end of the channel occupancy time.

3. The method of claim 2, wherein receiving the message further comprises:
receiving the message via unicast.

4. The method of claim 1, wherein the one or more shared resources are based at least in part on a transmission time of the message indicating the one or more shared resources.

5. The method of claim 4, wherein receiving the message further comprises:
receiving, via the message, a bitmap that indicates the one or more shared resources, wherein at least one bit of the bitmap indicates a shared resource of the one or more shared resources that is in relation to the transmission time of the message indicating the one or more shared resources.

6. The method of claim 4, wherein receiving the message further comprises:
receiving, via the message, one or more start and length indicator values for the one or more shared resources.

7. The method of claim 1, wherein the one or more shared resources are based at least in part on an offset and a duration related to a fixed frame period structure of the second UE.

8. The method of claim 1, further comprising:
receiving, from a base station, a table indicating the one or more shared resources.

9. The method of claim 8, wherein receiving the message further comprises:
receiving, from the second UE, a shared resource index; and
determining the one or more shared resources during the channel occupancy time based at least in part on accessing the table using the shared resource index.

10. The method of claim 8, wherein receiving the message further comprises:
receiving, from the second UE, a single bit resource sharing indication that indicates that a first symbol of the channel occupancy time is a shared resource.

11. The method of claim 10, wherein
the first symbol of the single bit resource sharing indication represents a first value plus a second value,
the first value is an end of a slot with which the first UE receives the single bit resource sharing indication and the second value is a quantity of symbols from the end of the slot with which the first UE receives the single bit resource sharing indication.

12. The method of claim 1, wherein receiving the message further comprises:
receiving the message via groupcast.

13. A method for wireless communication at a first user equipment (UE), comprising:
identifying that the first UE and a second UE are operating in an unlicensed spectrum and in a frame based equipment mode or a load based equipment mode for sidelink communications; and
transmitting, to the second UE, a first message indicating a first portion of one or more shared resources during a channel occupancy time, wherein the first portion of the one or more shared resources are available for the second UE to use for first sidelink transmissions.

14. The method of claim 13, wherein transmitting the first message further comprises:
transmitting, to a third UE, a second message indicating a second portion of the one or more shared resources during the channel occupancy time, wherein the second portion of the one or more shared resources are available for the third UE to use for second sidelink transmissions.

15. The method of claim 13, wherein transmitting the first message further comprises:
transmitting, via the first message, a single bit that indicates whether the second UE is allowed to transmit the first sidelink transmissions using the first portion of the one or more shared resources during a duration between when the second UE receives the first message and an end of the channel occupancy time.

16. The method of claim 15, wherein transmitting the first message further comprises:
transmitting the first message to the second UE via unicast.

17. The method of claim 13, wherein the one or more shared resources are based at least in part on a transmission time of the first message indicating the one or more shared resources.

18. The method of claim 17, wherein transmitting the first message further comprises:
transmitting, via the first message, a bitmap that indicates the one or more shared resources, wherein at least one bit of the bitmap indicates a shared resource of the one or more shared resources that is in relation to the transmission time of the first message indicating the one or more shared resources.

19. The method of claim 17, wherein transmitting the first message further comprises:
transmitting, via the first message, one or more start and length indicator values for the one or more shared resources.

20. The method of claim 13, wherein the one or more shared resources are based at least in part on an offset and a duration related to a fixed frame period structure of the first UE.

21. A method for wireless communication at a first user equipment (UE), comprising:
identifying that the first UE is operating in an unlicensed spectrum and in a frame based equipment mode for sidelink communications;
receiving, from a first wireless device, a fixed frame period configuration for a second wireless device, the fixed frame period configuration indicating a period and a time offset for the second wireless device;
determining a transmission duration for sidelink communications with a second UE based at least in part on the fixed frame period configuration for the second wireless device; and
transmitting, to the second UE, a sidelink message during the transmission duration.

22. The method of claim 21, wherein receiving the fixed frame period configuration further comprises:
receiving the fixed frame period configuration for the second wireless device from a base station.

23. The method of claim 22, wherein receiving the fixed frame period configuration further comprises:
receiving a table from the base station, wherein the table includes the fixed frame period configuration and an identifier of the second wireless device.

24. The method of claim 21, wherein receiving the fixed frame period configuration further comprises:
receiving the fixed frame period configuration from the second UE, wherein the fixed frame period configuration is for the second UE.

25. The method of claim 21, wherein receiving the fixed frame period configuration further comprises:
receiving a table from a base station, wherein the table includes a plurality of fixed frame period configurations corresponding to a plurality of UEs.

26. The method of claim 25, wherein receiving the fixed frame period configuration further comprises:
receiving, from the second UE, a table index indicating one fixed frame period configuration of the plurality of fixed frame period configurations of the table based at least in part on receiving the table from the base station.

27. The method of claim 21, wherein receiving the fixed frame period configuration further comprises:
receiving, from the second UE, sidelink control information, the sidelink control information indicating the fixed frame period configuration for the second UE.

28. A method for wireless communication at a base station, comprising:
identifying that a first user equipment (UE) is operating in an unlicensed spectrum and in a frame based equipment mode for sidelink communications;
determining a fixed frame period configuration for a first wireless device, the fixed frame period configuration indicating a period and a time offset for the first wireless device; and
transmitting, to the first UE, the fixed frame period configuration for the first wireless device.

29. The method of claim 28, wherein transmitting the fixed frame period configuration further comprises:
transmitting a table to the first UE, wherein the table includes the fixed frame period configuration for the first wireless device and an identifier of the first wireless device.

30. The method of claim 28, wherein transmitting the fixed frame period configuration further comprises:
transmitting a table to the first UE, wherein the table includes a plurality of fixed frame period configurations corresponding to a plurality of UEs.
